(19) United States
(12) Patent Application Publication
(10) Pub. No.: US 2011/0178837 A1
(43) Pub. Date: Jul. 21, 2011

(54) Systems and Methods for Managing Goodwill Activities in a Business Entity

(75) Inventors: Jürgen Goerges, Munchen (DE); Wolfgang Hastenpflug, Mering (DE); Jens Häussler, Munchen (DE); Thomas Lüthi, Munchen (DE); Kerstin Matthäus, Munchen (DE); Helge Seefeld, Munchen (DE); Christine Weyrich, Munich (DE)

(73) Assignee: Siemens AG

(21) Appl. No.: 12/975,999

(22) Filed: Dec. 22, 2010

Related U.S. Application Data
(60) Provisional application No. 61/295,805, filed on Jan. 18, 2010.

(51) Int. Cl. G06Q 10/00

(52) U.S. Cl. 705/7.28; 705/1.1

(57) ABSTRACT

Computer-implemented systems and methods for managing goodwill activities in a business organization are provided. A computer-implemented activity management tool collect user-submitted activity identification data regarding a proposed activity, and automatically classifies the proposed activity into one of a plurality of activity types based at least on the user-submitted activity identification data. The activity management tool also receives user-submitted activity value data regarding the proposed activity, automatically determines a value of the proposed activity based at least on the user-submitted activity value data, and automatically determines an appropriate approval level for the proposed activity based at least on the determined value of the proposed activity. The activity management tool also facilitates an approval process for the proposed activity based at least on the approval level determined for the proposed activity, including facilitating approval decisions by a selected set of one or more approvers via the computer network.

### CROSS-REFERENCE TO RELATED APPLICATIONS

This application claims the benefit of U.S. Provisional Application No. 61/295,805 filed on Jan. 18, 2010, entitled “SpoDoM—standardized workflow solution for the application and approval of activities related to sponsoring, hospitality packages, donations, memberships and other contributions without consideration”, which is incorporated herein in its entirety.

### TECHNICAL FIELD

The present disclosure relates generally to the field of facilitating the management of goodwill activities in a business entity, e.g., sponsoring, hospitality packages, donations, memberships and other contributions without consideration by persons affiliated with a business entity.

### BACKGROUND

Many companies have adopted social responsibility programs for building goodwill in the respective communities, for building relationships, and for various other reasons. Social responsibility programs typically include a variety of “goodwill activities,” such as sponsoring, hospitality packages, donations, memberships, invitations, and other contributions to third parties.

As such social responsibility programs have grown, the evaluation and approval of goodwill activities has become difficult to manage, due to the number of goodwill activities, the number of relevant legal and business-specific regulations, among other reasons.

There are various problems associated with managing a social responsibility program for a business organization. One common problem is the application of different criteria for the evaluation and approval of goodwill activities by different sectors, divisions, business units, or other business entities business organization. Another common problem is that different processes are used for the evaluation and approval of goodwill activities by different sectors, divisions, business units, or other business entities business organization.

Another common problem is the ambiguous or non-standardized categorization or activities into defined types of goodwill activities, such as sponsoring activities, hospitality packages, donations, memberships, etc. Another common problem is the lack of global transparency and monitoring of goodwill activities, and thus a risk of redundant or non-synchronized activities.

### SUMMARY

In some embodiments of the present disclosure, a computer-implemented method for managing goodwill activities in a business organization is provided. The method includes collecting user-submitted activity identification data regarding a proposed activity via a computer network, and automatically classifying the proposed activity into one of a plurality of activity types based at least on the collected activity identification data. The method further includes collecting user-submitted activity value data regarding the proposed activity via the computer network, automatically determining a value of the proposed activity based at least on the collected activity value data, and automatically selecting from a plurality of approval levels an approval level for the proposed activity based at least on the determined value of the proposed activity and approval rules defined for the respective entities. The method further includes facilitating an approval process for the proposed activity based at least on the approval level selected for the proposed activity, including facilitating approval decisions by a selected set of one or more approvers via the computer network.

In some embodiments of the present disclosure, software stored in tangible memory and executable by one or more processors is provided. The software, when executed, is operable to: collect user-submitted activity identification data regarding a proposed activity via the computer network; automatically classify the proposed activity into one of a plurality of activity types based at least on the collected activity identification data; collect user-submitted activity value data regarding the proposed activity via the computer network; automatically determine a value of the proposed activity based at least on the collected activity value data; automatically select from a plurality of approval levels an approval level for the proposed activity based at least on the determined value of the proposed activity; and facilitate an approval process for the proposed activity based at least on the approval level determined for the proposed activity, including facilitating approval decisions by a selected set of one or more approvers via the computer network.

In some embodiments of the present disclosure, a system for managing goodwill activities in a business organization is provided. The system includes a host device communicatively connected to a plurality of user devices by a computer network. The host device includes a goodwill activity management tool embodied in tangible memory and executable by one or more processors. The goodwill activity management tool includes at least an activity identification module, a key data module, an assessment moudule including a strategic and compliance section and an approval module. The activity identification module is configured for collecting user-submitted activity identification data regarding a proposed activity via the computer network, and automatically classifying the proposed activity into one of a plurality of activity types based at least on the collected activity identification data. The key data module is configured for collecting user-submitted activity value data regarding the proposed activity via the computer network, and automatically determining a value of the proposed activity based at least on the collected activity value data. The approval module is configured for automatically selecting from a plurality of approval levels an approval level for the proposed activity based at least on the determined value of the proposed activity, and facilitating an approval process for the proposed activity based at least on the approval level determined for the proposed activity, including facilitating approval decisions by a selected set of one or more approvers via the computer network. The approval hierarchy can be maintained individually for activity types and entities working with the same system

Systems and methods according to certain embodiments disclosed herein may provide one or more advantages as compared to current systems and methods. In general, embodiments of systems and methods disclosed herein may provide a harmonized and efficient integrated workflow process for goodwill activities, thus providing an adequate management decision base.

For example, certain embodiments may provide or facilitate a decentralized evaluation and approval of goodwill activities and possible central and local transparent reporting and monitoring.

As another example, certain embodiments may provide or facilitate unambiguous categorization of goodwill activities according to policy definitions supported by standardized, electronic identification checklists.

As another example, certain embodiments may provide or facilitate the possibility to upload specific process descriptions (e.g., tax regulations) and signature regulations for different activity types by each different business entity within a larger business organization, as guidance for users.

As another example, certain embodiments may provide or facilitate an appropriate workload for the evaluation of goodwill activities, in which information to be provided depends on the value of the activity and a compliance risk evaluation.

As another example, certain embodiments may provide or facilitate an approval process that considers centrally defined minimum requirements, as well as the possibility to map local requirements (e.g. signature regulations).

### BRIEF DESCRIPTION OF THE DRAWINGS

Some embodiments of the disclosure may be understood by referring, in part, to the following description and the accompanying drawings wherein:

FIG. 1 illustrates a system for facilitating the management of a social responsibility program for a business organization, including a goodwill activity management tool, in accordance with certain embodiments;

FIGS. 2-6 illustrate example applications of example rules for classifying various activities according to type of goodwill activity;

FIG. 7 illustrates an example process flow for the evaluation, approval, execution of a goodwill activity using the goodwill activity management tool, according to certain embodiments.

FIG. 8 illustrates an example process flow for a “pre-work” phase and an activity assessment phase of the goodwill activity evaluation, approval, execution process, according to certain embodiments;

FIG. 9 illustrates an example approver selection matrix for determining the level of approval required for a proposed activity, according to certain embodiments;

FIG. 10 illustrates an example screenshot from the activity execution phase, according to certain embodiments;

FIG. 11 illustrates an example matrix of roles and authorization levels defined by the goodwill activity management tool, according to certain embodiments;

FIGS. 12-52 are example screenshots and other relevant data illustrating various functions performed or facilitated by the goodwill activity management tool, according to one example embodiment;

FIG. 53 illustrates an example process flow for the evaluation, approval, execution of an invitation type activity using an invitation approval tool, according to certain embodiments;

FIGS. 53-61 are example screenshots and other relevant data illustrating various functions performed or facilitated by the invitation approval tool, according to one example embodiment; and

FIG. 62 illustrates an example screenshot of a translation tool, according to one example embodiment.

### DETAILED DESCRIPTION OF THE DRAWINGS

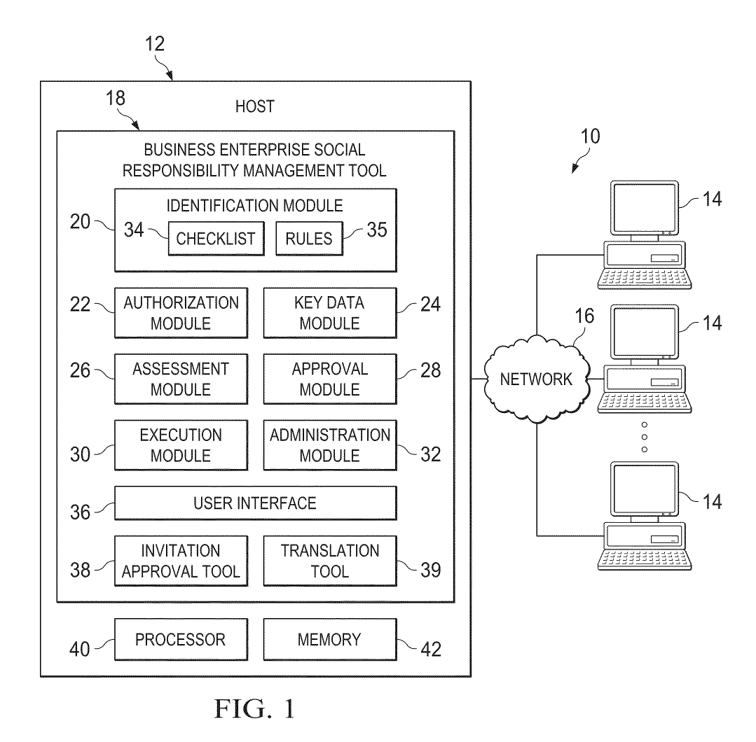

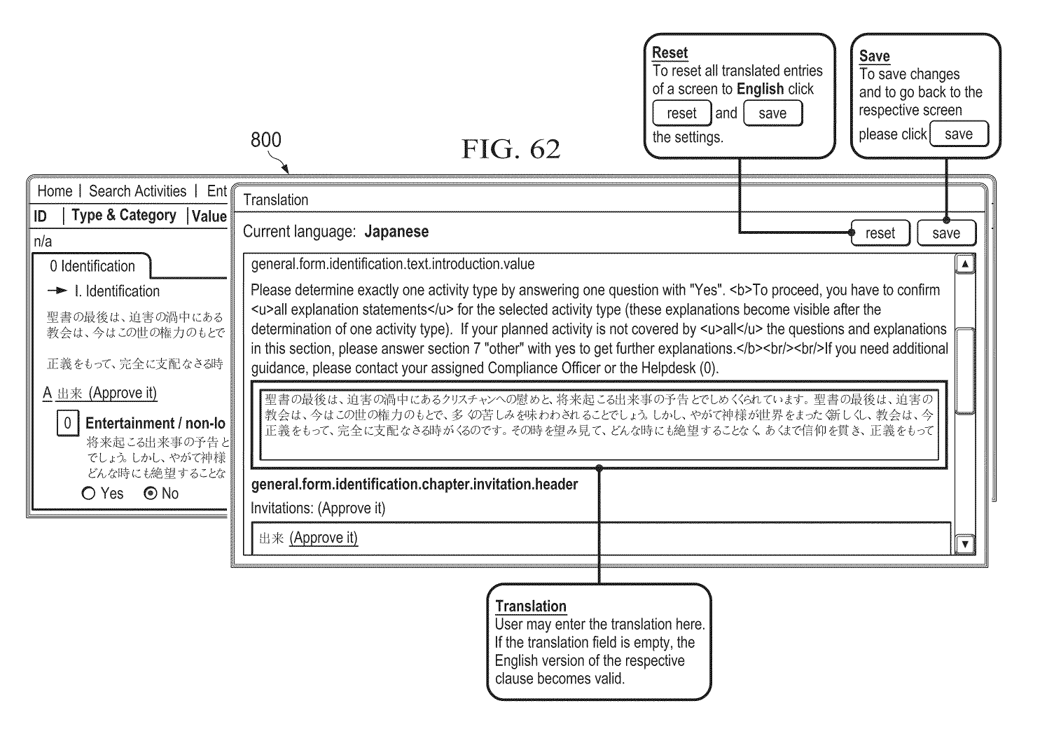

Selected embodiments of the disclosure may be understood by reference, in part, to FIGS. 1-62, wherein like numbers refer to same and like parts. The present disclosure is broadly concerned with systems and methods for facilitating the management of goodwill activities in a business entity, e.g., sponsoring, hospitality packages, donations, memberships, invitations (e.g., entertainment and non-local travel and lodging for third parties), and other contributions without consideration. In some embodiments, a “goodwill activity management tool” tool is provided for managing the evaluation and approval of different types of goodwill activities. The goodwill activity management tool may comprise a software application accessible to some or all members of a business entity.

FIG. 1 illustrates a system 10 for facilitating the management of a social responsibility program for a business organization, in accordance with certain embodiments. System 10 includes a host 12 communicatively connected to a number of user terminals 14 by a network 16. Host 12 may comprise any type of computer system operable to host a goodwill activity management tool 18. In certain embodiments, host 12 may be a server. In another embodiment, host 12 may be a personal computer. In some embodiments, goodwill activity management tool 18 may be hosted by a particular user terminal 14, or an instance of goodwill activity management tool 18 may be hosted by each user terminal 14.

As depicted in FIG. 1, host 12 may include a processor 40, memory 42 communicatively coupled to processor 40, and any other suitable components for executing goodwill activity management tool 18.

Processor 40 may comprise any system, device, or apparatus operable to interpret and/or execute program instructions and/or process data associated with goodwill activity management tool 18, and may include, without limitation, a microprocessor, microcontroller, digital signal processor (DSP), application specific integrated circuit (ASIC), or any other digital or analog circuitry configured to interpret and/or execute program instructions and/or process data associated with goodwill activity management tool 18. In some embodiments, processor 40 may interpret and/or execute program instructions and/or process data stored in memory 42 and/or another component of host 12.

Memory 42 may be communicatively coupled to processor 40 and may include any computer-readable media suitable for storing any data or logic associated with goodwill activity management tool 18. For example, memory 42 may include computer-readable media for storing data and logic instructions associated with identification module 20, authorization module 22, key data module 24, assessment module 26, approval module 28, execution module 30, administration module 32, and user interface 36 of goodwill activity management tool 18. For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; and/or any combination of the foregoing.

Each user terminal 14 may include any type of computer suitable for interacting with goodwill activity management tool 18, e.g., a personal computer, a laptop, a PDA, etc. Each terminal 14 may include any suitable hardware for interacting with goodwill activity management tool 18, e.g., processors, memory, software, and input and output (I/O) devices (e.g., a keyboard, a mouse, and a video display).

In some embodiments, goodwill activity management tool 18 is hosted locally by one or more user terminals 14, allowing directly access to tool 18. In some embodiments, goodwill activity management tool 18 is hosted by host 12 and accessible at each user terminal 14 via network 16. Thus, each terminal 14 may include a browser application for accessing goodwill activity management tool 18 via network 16 (e.g., an intranet or the Internet). In other embodiments, goodwill activity management tool 18 is hosted locally by one or more user terminals 14, allowing directly access to tool 18.

Network 16 may be a network and/or fabric configured to couple host 12 to target device 120. Network 16 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) between host 12 and user terminals 14. Network 16 may transmit data using wireless transmissions and/or wire-line transmissions via any storage and/or communication protocol. Network 16 and its various components may be implemented using hardware, software, or any combination thereof In some embodiments, network 16 allows user terminals 14 to access goodwill activity management tool 18 via an intranet, such as a company-wide intranet. In other embodiments, network 16 allows user terminals 14 to access goodwill activity management tool 18 via the Internet.

Goodwill activity management tool 18 is generally operable to facilitate the goodwill activity management discussed herein. Goodwill activity management tool 18 includes an identification module 20, an authorization module 22, a key data module 24, an assessment module 26, an approval module 28, an execution module 30, an administration module 32, an invitation approval tool 38, a translation tool 39, and a user interface 36.

User interface 36 is generally configured to allow a user to interact with tool 18. User interface 36 may comprise any instrumentality or aggregation of instrumentalities by which a user may interact with tool 18. For example, user interface 36 may include a series of web pages or screens providing data to a user at user terminal 14, prompting the user for data, and providing interfaces (e.g., text fields, menus, check boxes, etc.) allowing the user to enter data with an input device (e.g., a keyboard or pointing device).

Identification module 20 is generally configured to identify and classify goodwill activities (e.g., sponsoring, hospitality packages, donations, memberships, invitations, and other contributions without consideration) undertaken by users associated with a business organization (e.g., employees or owners of the business organization). More specifically, identification module 20 may facilitate the collection of data (via user terminals 14) from users related to a business organization regarding various activities and, based on such collected data, (a) identify whether particular activities qualify as “goodwill activities” (e.g., based on rules such as whether or not the business organization received consideration for the particular activity) and (b) classify qualifying activities into specific types of goodwill activities (e.g., sponsoring, hospitality packages, donations, memberships, invitations, or other contributions without consideration). Identification module 20 may include questions (e.g., identification checklists 34), rules (e.g., rules 35), and/or algorithms for identifying/classifying goodwill activities corresponding to data entered by users of tool 18.

Authorization module 22 is generally configured to manage user authorization for accessing (via tool 18) activities entered by other users. For example, authorization module 22 may allow the user who enters a goodwill activity into tool 18 (e.g., as facilitated by identification module 20), referred to herein as the “activity originator,” to grant one or more other users (e.g., co-workers) different levels of rights to access the goodwill activity via tool 18. For example, authorization module 22 may allow the activity originator to specify one or more other users as “co-originators” having editing rights, or “viewers” having read-only rights, to the entered data regarding the goodwill activity.

Key data module 24 is generally configured to collect and/or analyze key data regarding goodwill activities entered by users of tool 18. More specifically, key data module 24 collects various data regarding each goodwill activity entered by an originator and/or co-originator(s), such as for example, the recipient or beneficiary of the goodwill activity, the business entity within the larger business organization that is responsible for the goodwill activity, the monitory equivalent or other value-related information regarding the goodwill activity, etc. Key data module 24 may include any suitable questions and/or algorithms for collecting and/or analyzing such key data.

Assessment module 26 is generally configured to assess goodwill activities entered by users of tool 18. More specifically, assessment module 26 may facilitate (1) a strategic assessment phase for collecting information from the user regarding the purpose and the strategic direction of the goodwill activity, and (2) a compliance risk assessment phase for assessing any potential compliance risks (e.g., violations of laws or business rules) associated with the goodwill activity. For the strategic assessment phase, assessment module 26 may select questions to present to the user based on the value of the goodwill activity (e.g., the value collected or determined by key data module 24). For the strategic assessment phase, assessment module 26 may determine, based on user input regarding the goodwill activity, appropriate compliance organization(s) or person(s) for approving the goodwill activity.

Approval module 28 is generally configured to manage approval decisions for goodwill activities entered by users of tool 18. More specifically, approval module 28 may facilitate the automatic identification and/or user selection of one or ore persons to approve a goodwill activity (referred to as “approvers”), as well as facilitating the actual approval decision by the one or more approvers. Approval module 28 may allow the activity originator to select approvers from predefined approvers groups, according to a known set of rules (e.g., a signature mandate), and/or to manually enter one or more other approvers. Approval module 28 may automatically display compliance entities (e.g., compliance officers or company officers) based on the determined compliance risks and/or value of the goodwill activity, e.g., as determined by key data module 24 and/or assessment module 26. Approval module 28 may allow the activity originator to specify the order of the approval process (i.e., the order in which the goodwill activity is presented to the approvers for approval), and submit the activity for approval. Approval module 28 may then manage the actual approval decisions by the approvers, including generating automatic notifications (e.g., email reminders) to each approver as appropriate.

Execution module 30 is generally configured to collect from users documents and other information related to the execution of approved goodwill activities. For example, execution module 30 may facilitate the collection of receipts, vouchers, contracts, the current status of the activity, and an evaluation of the activity outcome.

Administration module 32 is generally configured to facilitate administrative functions by designated administrators. For example, administration module 32 may allow an administrator to (1) manage thresholds used by tool 18 for making various decisions (e.g., activity value thresholds for triggering involvement of a compliance officer), (2) specify approvers or an approver group for a particular business entity (for approving goodwill activities), (3) define rules for approving goodwill activities and define the sequence for the approval, (4) upload or add signature (i.e., approval) regulation documents, and/or (5) upload or add other documents specific to a particular business entity.

Invitation approval tool 38 is generally configured to manage the approval process for “invitation” type activities, e.g., invitations of third parties to events for entertainment purposes and/or payment of costs for non-local travel and lodging (accommodation) for such third parties. As discussed below, the process flow for evaluating, approving, and executing “invitation” type activities may be managed by invitation approval tool 18, and may share some aspects of the process flow for evaluating other types of activities (e.g., sponsoring, hospitality packages, donations, and memberships), but may provide additional aspects specific to “invitation” type activities. Thus, invitation approval tool 38 may utilize one or more of authorization module 22, key data module 24, assessment module 26, approval module 28, execution module 30, and/or administration module 32 for providing certain functions, or alternatively, invitation approval tool 38 may provide such functions itself.

In some embodiments, e.g., as shown in FIG. 1, invitation approval tool 38 is part of tool 18. In other embodiments, invitation approval tool 38 is separate from tool 18, but may interact with tool 18 to share various data and/or functionality.

Translation tool 39 provides multiple language translations of text displayed by tool 18, and allows defined “translators” to edit the respective translations.

Goodwill activity management tool 18 may include any other modules or components suitable for performing any of the various functions disclosed herein. Each functional module of tool 18—including identification module 20, authorization module 22, key data module 24, assessment module 26, approval module 28, execution module 30, and administration module 32—may include any suitable software (and/or other logic instructions) stored in tangible computer-readable media, such as memory 42 and/or other memory device(s), and executable by one or more processors, such as processor 40 and/or other processor(s), for performing any of the various functions associated with such functional modules.

As discussed above, identification module 20 may include rule 35 for identifying whether activities qualify as “goodwill activities”, as well as classifying goodwill activities by type, based on data entered by users of tool 18, e.g., in response to questions such as identification checklists 34. In an example embodiment, rules 35 for an example business organization—ABC Company—define the following types of goodwill activities: (a) sponsoring, (b) donations, (c) memberships, (d) hospitality packages, (e) invitations (e.g., entertainment and non-local travel and lodging for third parties), and (f) other contributions without consideration. Such rules 35 may classify each type of goodwill activity according to the rules and definitions provided below.

Sponsoring. “Sponsoring” means any contribution in money or in kind by ABC Company (or an affiliated company) towards an event or a promotional platform (e.g., sports club, cultural even, congress) owned, operated or organized by a third party for which ABC Company receives an adequate consideration in return, which is often bundled. Typically this involves ABC Company providing a contribution (in money or in-kind) in exchange for some consideration (e.g., ABC Company logo on event tickets, advertisement in an event program, banners, etc.).

Example rules 35 may specify that an activity is categorized as “sponsoring” only if all of the following criteria are fulfilled:

(a) The ABC Company brand is associated with the platform and/or ABC Company technologies are promoted via this platform.

(b) ABC Company receives marketing rights and/or services, often as a bundle, in return for the contribution.

(c) ABC Company supports the platform and the activity is used for ABC Company communication purposes.

(d) The activity is not a purchase or pure advertising or marketing services.

Further, rules 35 may specify that:

(a) Sponsoring activities require a written sponsoring agreement specifying at least the recipient, its banking details, the exact amount of the contribution, the event for which the funds are earmarked and the consideration ABC Company will collect in return.

(b) Sponsoring activities must be justified by a legitimate and plausible business purpose.

(c) Sponsoring activities must not be focused solely on one individual.

(d) The contribution offered by ABC Company must be proportionate to the consideration it receives in return (based on defined numerical ranges); and

(e) Expenditures for the purchase of specific marketing activities, services or opportunities from a third party are marketing expenses and are outside the scope of “sponsoring”.

Donations. A “donation” is a voluntary contribution to external parties where ABC Company (or an affiliated company) is not paid or receives nothing tangible in return, for cultural, scientific, environmental or humanitarian purposes. A donation can be a financial benefit, an in-kind donation, or a donation of voluntary working hours to external parties. Donations mostly are given to charitable organizations and are tax deductible in many countries.

Example rules 35 may specify that an activity is categorized as a “donation” only if all of the following criteria are fulfilled:

(a) The objective of the charitable contribution is to support cultural, educational, humanitarian or environmental purpose.

(b) The consideration that ABC Company receives in return is negligible in value.

(c) The recipient organization has a tax-exempt status under local tax law. Or: Charitable organization in your country do not have a tax-exempt status under local tax law.

Further, rules 35 may specify that:

(a) Donations may not be made for political or religious purposes.

(b) Donations to a for-profit organization or to an organization whose goals are not compatible with ABC Company's defined company principles are not allowed.

(c) The recipient will provide a written official document confirming the donation (i.e., donation receipt) if necessary.

(d) A contribution is still considered “without consideration” if ABC Company is offered a consideration in return which it did not seek or which has no or little value to ABC Company (e.g., mentioning the donation in a publication of the recipient or put the ABC Company logo on a website).

Further, rules 35 may specify that:

(a) A donation shall (if possible) only be made if it is tax-deductible, which depends on the relevant national tax law. In countries in which donations are never tax-deductible, this criteria does not apply. Contributions for a for-profit organization, e.g., to a commercial media company or to a purely commercial research institute do not classify as donations.

(b) Contributions for a purpose that does not correspond to a predefined area (e.g., education and science, arts and culture, social and humanitarian affairs, and environment and climate change). Donations for sports, e.g., a tennis tournament, do not qualify as donations.

(c) Donations are differentiated from marketing expenses. When ABC Company receives a consideration in return, also in means of communication, the contributions is likely a sponsoring or marketing expense, not a donation.

(d) Donations are differentiated from other contributions without consideration. In countries where donations are generally tax-deductible, donations can only be made to organizations that are entitled to provide the originator or ABC Company a tax-deductible receipt. In countries in which donations are generally not tax-deductible, this criteria does not apply.

Memberships. A “membership” means that ABC Company (or an affiliated company) or an employee of ABC Company who acts in the interest/on behalf of ABC Company joins an association (e.g., a chamber, club, standardization body, professional organization, trade organization) that confers membership rights and imposes obligations on the member such as representation in the bodies of the entity, membership fee or admission fee.

Example rules 35 may specify that an activity is categorized as a “membership” only if all of the following criteria are fulfilled:

(a) ABC Company pay a membership fee and/or an admission fee for the membership.

(b) The membership is not for a single event.

(c) The membership includes rights and obligations for the member that are defined in a charter of the association (e.g., participation in the bodies of the association such as general assembly).

Further, rules 35 may specify that:

(a) The membership is in the interests of ABC Company and/or it subsidiaries only, i.e., the membership must not be used privately.

(b) The purpose of the membership is to reach defined objectives.

(c) The organization in question is not a political party.

(d) The membership is for the purpose of lobbying or networking (including also the development of technical standards) or of fulfilling a legal requirement.

(e) Allowances for personal membership of an ABC Company employee that are covered in the employee's employment contract do not qualify as memberships.

(f) For-free memberships do not qualify as memberships.

Hospitality Packages. “Hospitality packages” are tickets or packages including the tickets and other services (e.g., meals and/or accommodation) for events, particularly in the fields of art, culture, and sports (e.g., the Olympics or opera festivals) that have been purchased to entertain external guests in connection with ABC Company's hospitality activities. Examples for hospitality packages include tickets to a major even (e.g., Soccer World Cup, Olympic Games, University games), sky boxes in stadiums and event venues, season tickets to sports venues or cultural institutions, and tickets to award ceremonies, gals, or opera balls.

Example rules 35 may specify that only hospitality packages with a value exceeding a threshold value (e.g., 25,000 Euros or equivalent in local currency) per event.

Invitations. “Invitations” include invitations of third parties to events for entertainment purposes and/or payment of costs for non-local travel and lodging (accommodation) for such third parties. Example rules 35 may specify that gifts and invitations to meals do not qualify as “invitations,” and may require the originator to evaluate such benefits using a “provision scorecard” outside of tool 18 and consult an appropriate compliance organization if indicated by the results of the provision scorecard.

Other Contributions without Consideration. “Other Contributions without Consideration” include any voluntary contributions in money or in-kind without consideration (i.e., where ABC Company and affiliated companies is not paid and receives nothing tangible in return) to a third party entity (e.g., customer or vendor) that do not quality as a donation and that have a commercial background such as an existing business relationship with the recipient. In other words, ABC Company provides a contribution (financial or in-kind contribution) that does not qualify as a donation, and receives no consideration in return.

Some examples of “other contributions without consideration” includes ABC Company sponsoring a customer or vendor's internal employee party, ABC Company “donating” 100 teddy bears to a private hospital and the contribution is not recognized as a donation under the relevant national law, or ABC Company contributing a product to a customer's New Year's raffle.

Example rules 35 may specify that an activity is categorized as an “other contributions without consideration” only if all of the following criteria are fulfilled:

(a) The consideration that ABC Company receives in return is negligible (according to defined thresholds).

(b) The recipient is a legal person, organization, or entity and not an individual.

(c) The contribution is not recognized as a donation under national tax law.

Further, rules 35 may specify that:

(a) The recipient is not an individual or a private bank account.

(b) The contribution is not for a political or religious purpose.

(c) The contribution has a commercial background such as an existing or potential supplier or customer relationship or reputational purposes.

(d) A contribution is still considered “without consideration” if ABC Company is offered a consideration in return which it did not seek or which has no or little value to ABC Company (e.g., mentioning the contribution in the recipient's internal publication)

Rules 35 may specify that all activities classified as sponsoring activities, donations, memberships, other contributions without consideration, and the purchase of hospitality packages (above the threshold value, e.g., 25,000 Euros) must be registered via tool 18 and must obtain approval via tool 18 before any commitment is made. As discussed above, tool 18 identification module 20 assists the activity originator in determining the correct classification for the activity.

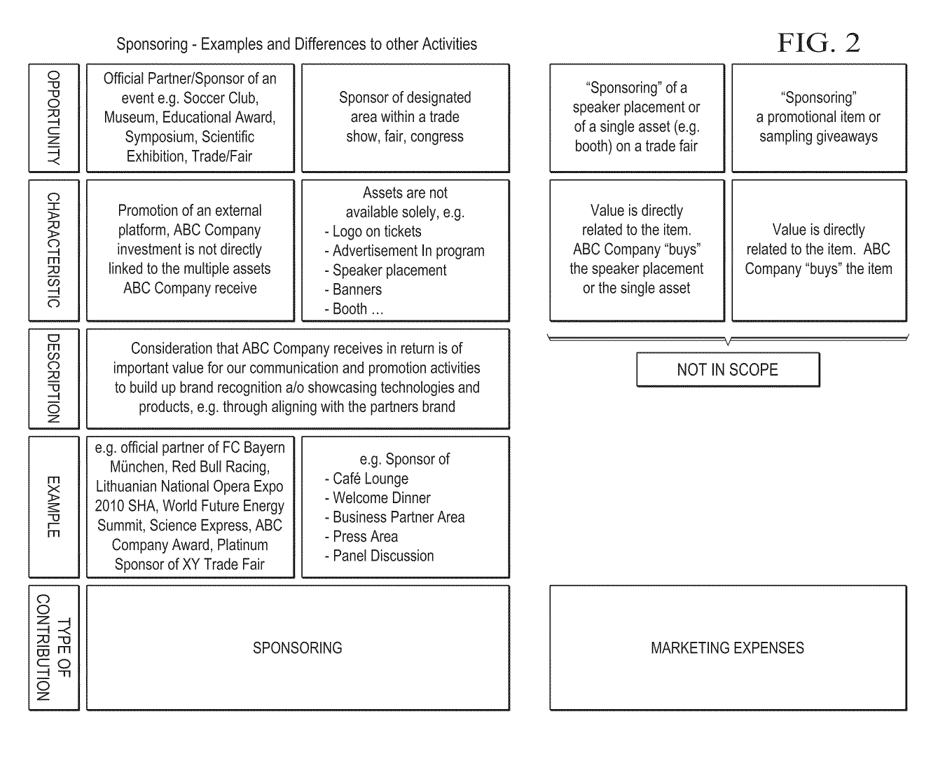

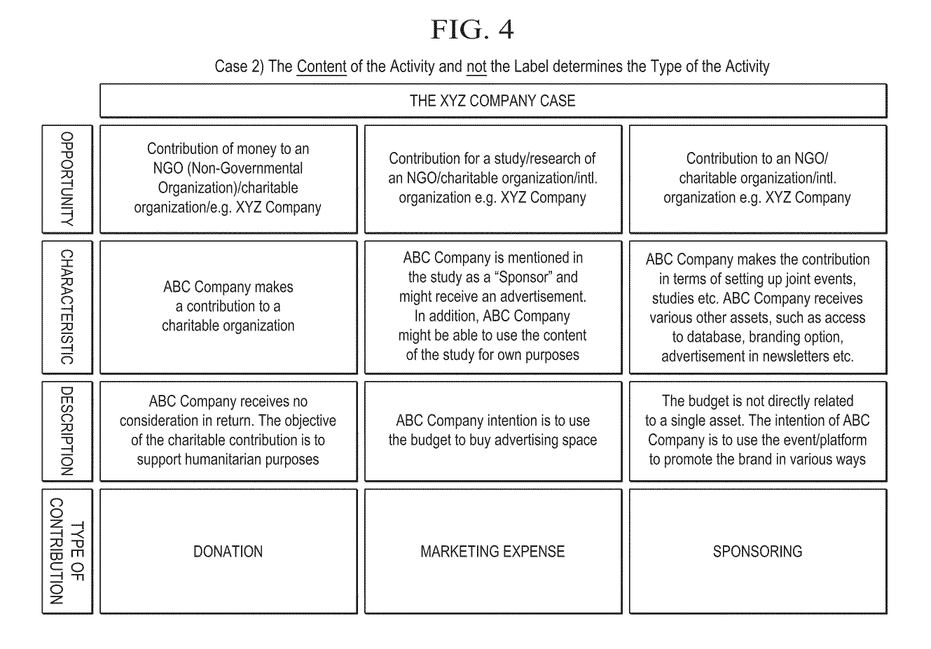

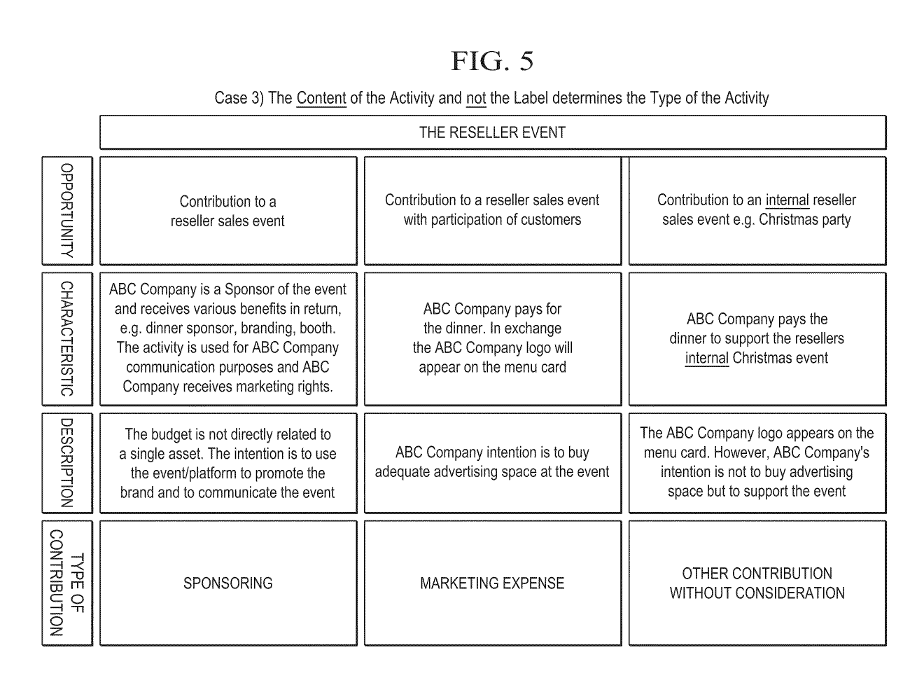

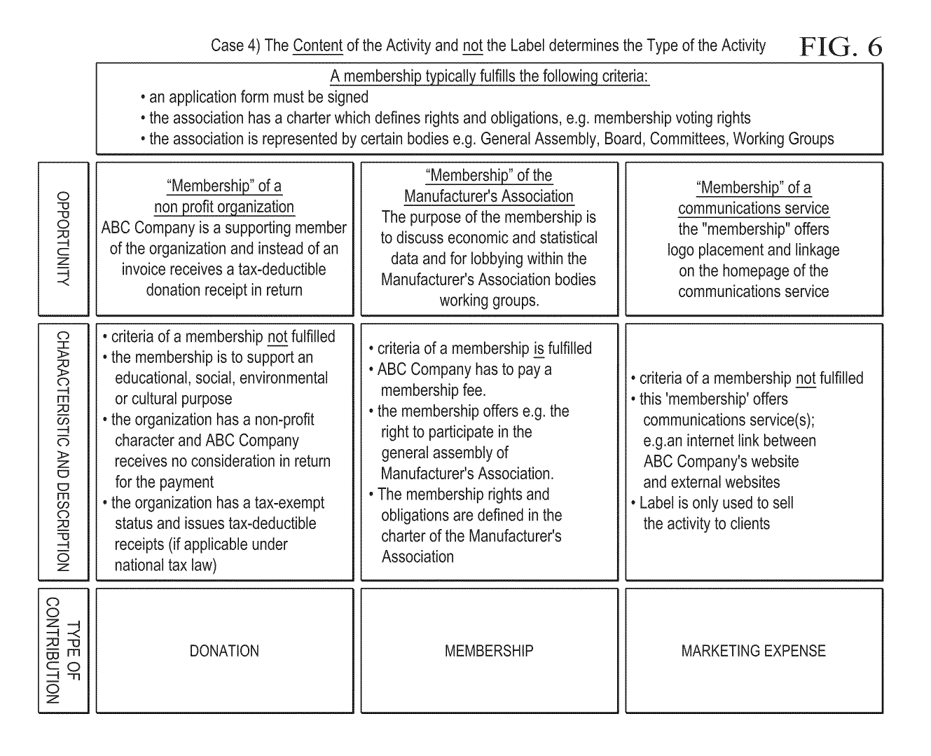

FIGS. 2-6 illustrate some example applications of example rules 35 for classifying various activities according to type of goodwill activity, or not classifying as a goodwill activity (e.g., marking expenses).

FIG. 2 illustrates example applications of example rules 35 for classifying various activities as “sponsoring” (which must be evaluated via tool 18) or marketing expenses (which are outside the scope of tool 18).

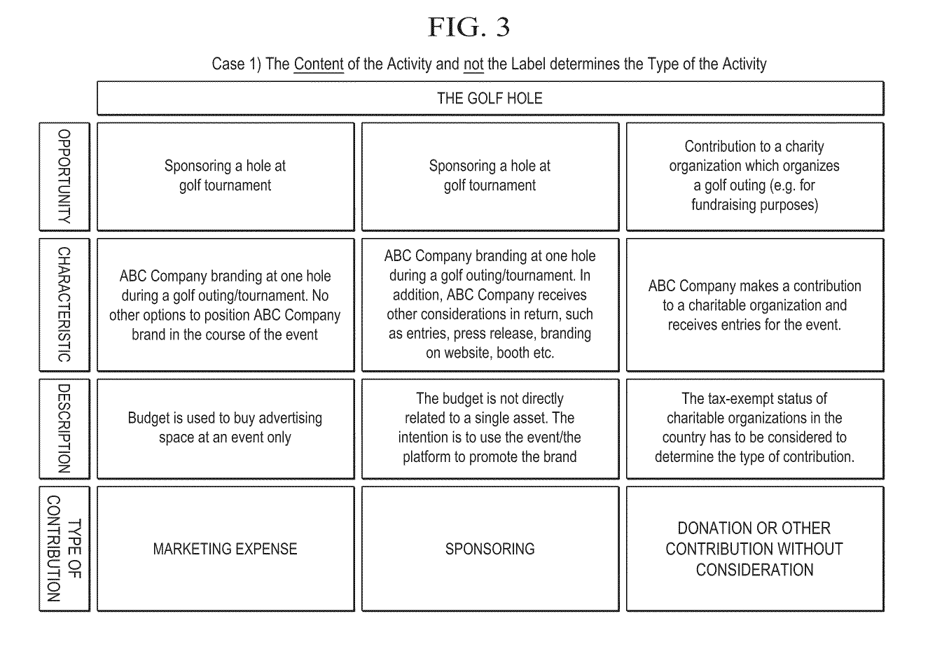

FIGS. 3-6 illustrate that example applications of example rules 35 for classifying various activities as “sponsoring”, “donations”, “donations”, or “other contribution without consideration” (which must be evaluated via tool 18) or marketing expenses (which are outside the scope of tool 18). FIGS. 3-6 demonstrate that the content of the activity, and not the label of the activity, determines the classification of the activity.

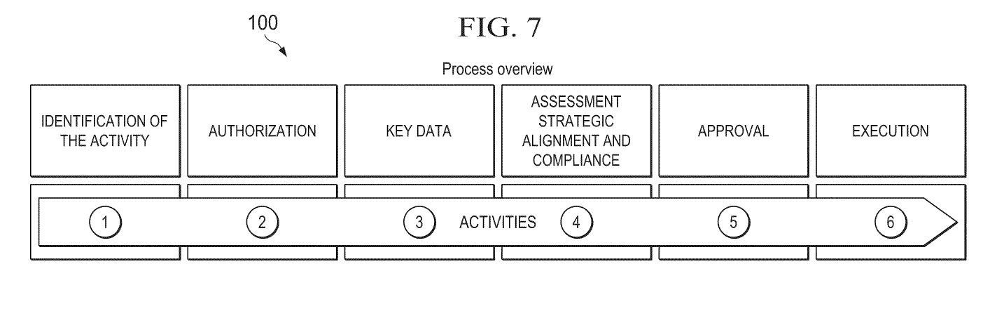

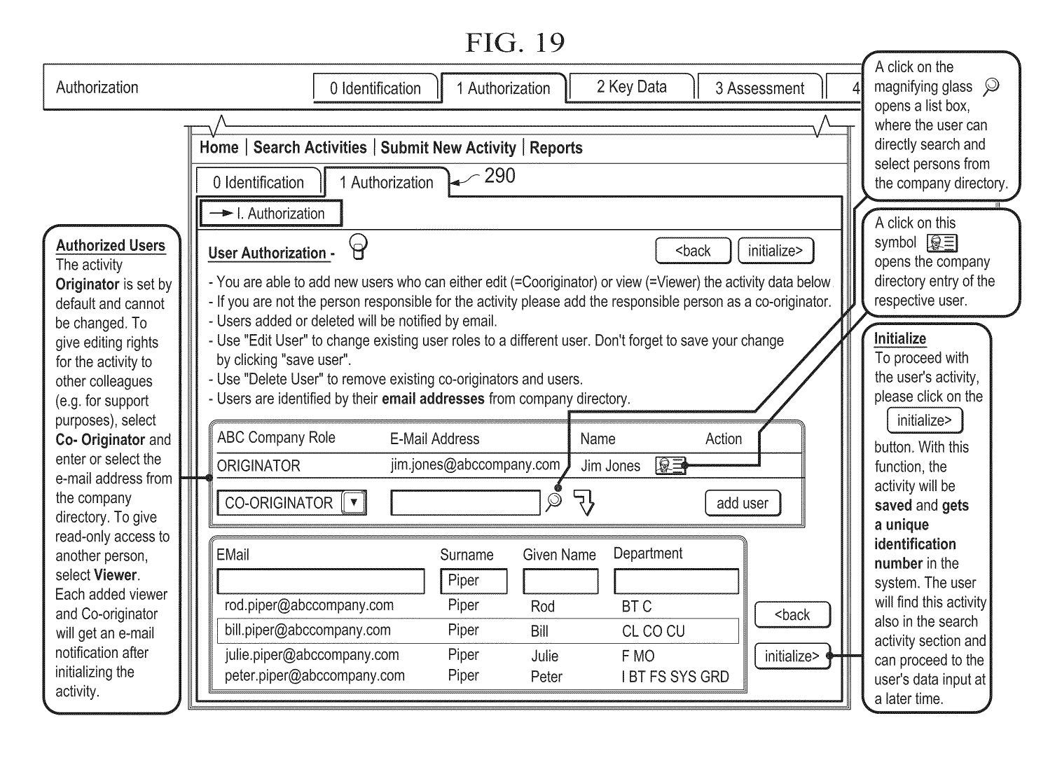

FIG. 7 illustrates an example process flow 100 for the evaluation, approval, and execution of a goodwill activity using tool 18, according to certain embodiments. In this example, the evaluation process for goodwill activities (sponsoring, donations, donations, hospitality packages, and other contribution without consideration) includes five phases: an identification of the activity phase (1), an authorization phase (2), a key data phase (3), an assessment phase (4), and an approval phase (5). An execution phase (6) becomes visible (via tool 18) after the approval of the activity and provides an approval voucher, which may be necessary for ABC Company's accounting department to book contributions to correct accounts with a reference to the activity ID number (discussed below with reference to FIG. 19). The first four phases (1)-(4) are performed by the department within the business entity of ABC Company that proposes the activity. The approval phase (5) is conducted by authorized persons according to local (e.g., business entity specific) signature regulation and, if applicable, by the compliance organization who is responsible for that business entity.

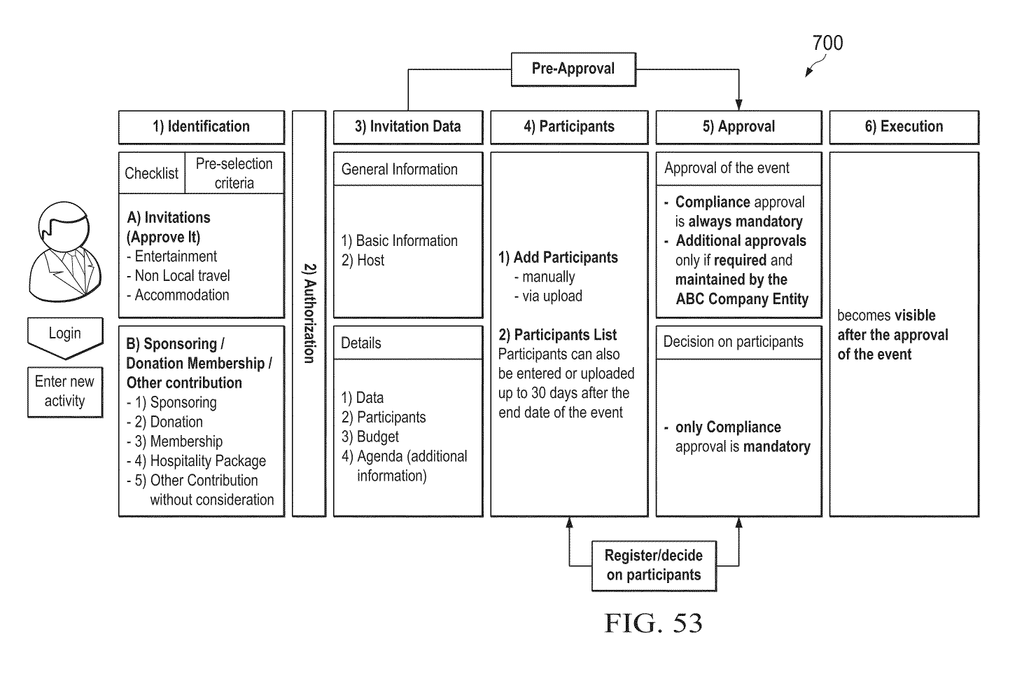

The process flow for evaluating, approving, and executing an “invitation” type activity may be managed by invitation approval tool 18, and may share some steps of process flow 100 but include additional steps specific to “invitation” type activities. The process flow for “invitation” type activities is discussed below with reference to FIGS. 53-61.

Returning to example process flow 100, during the identification of the activity phase (1), the activity type is identified through interaction between the activity originator and identification module 20. Identification module 20 may facilitate this identification using identification checklists 34 for each activity type. In addition, certain criteria defined for activity types must be confirmed.

During the authorization phase (2), authorization module 22 allows the originator to assign viewer rights and/or editor rights to other persons. By finalizing this phase, the activity is recorded in the database. During the key data phase (3), key data module 24 interacts with the originator (or other authorized user) to collect key data for the activity and a basic description of the planned transaction.

During the assessment phase (4), assessment module 26 interacts with the originator (or other authorized user) to collect additional information regarding the activity and answers to various compliance questions, to provide an adequate basis for the approval decision. During the approval phase (5), approval module 28 interacts with specified approvers (e.g., compliance officers) in order to approve or reject the activity based on the information provided by the department that applied for the activity.

Finally, during the execution phase (6), execution module 30 facilitates the uploading and/or documenting of information concerning the execution and measurement of the activity. In addition, the approval voucher for the accounting department is generated.

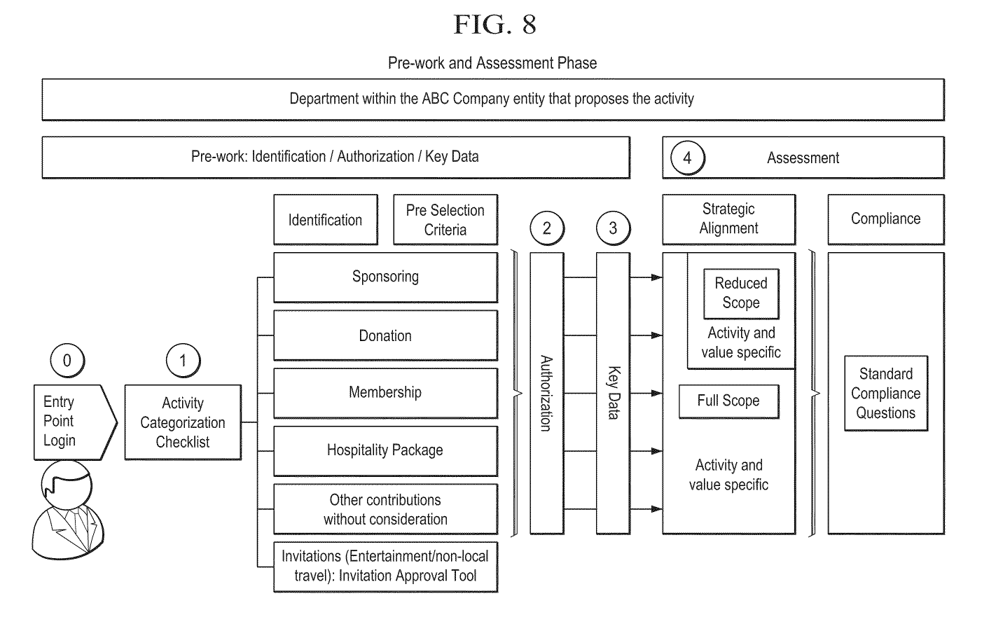

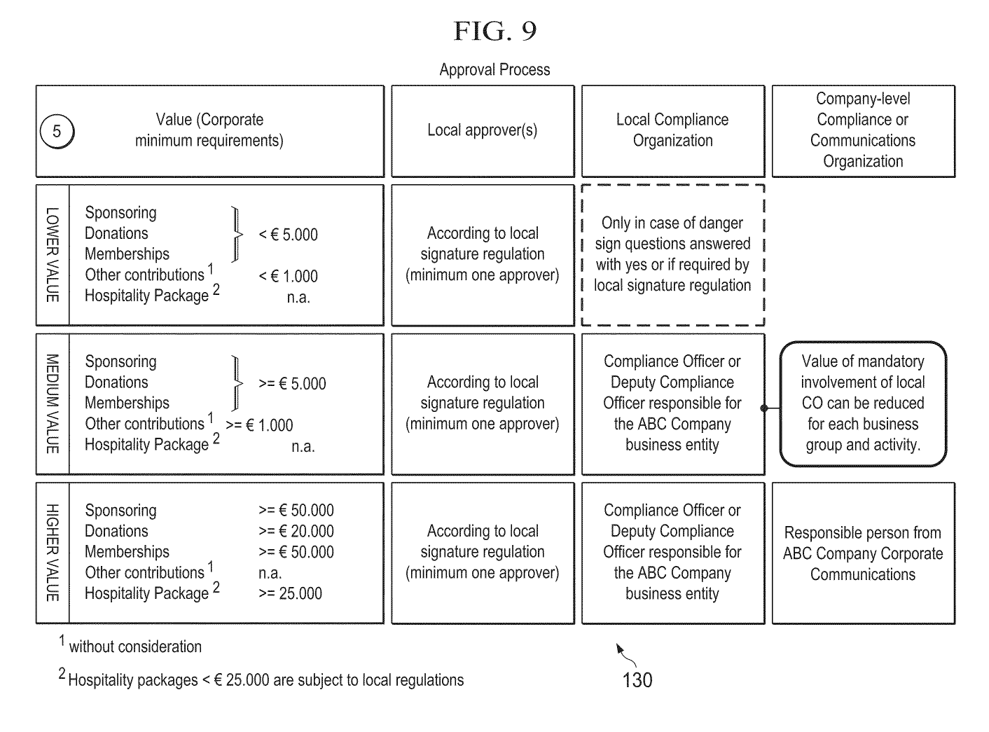

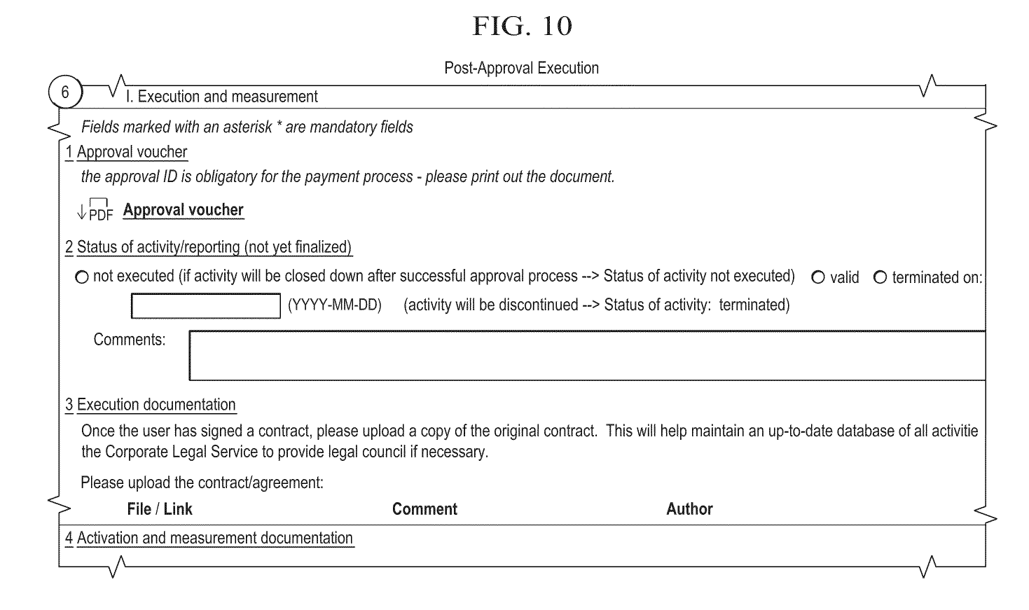

FIGS. 8-10 illustrate a more detailed view of example process flow 100 shown in FIG. 7. In particular, FIG. 8 illustrates an example process flow for the so-called “pre-work” phase (login, activity identification, authorization, and key data collection) and the activity assessment phase; FIG. 9 illustrates an example approver selection matrix for determining the level of approval required for the proposed activity based on the value of proposed activity; and FIG. 10 illustrates an example screenshot from the activity execution phase, according to certain embodiments.

Referring to FIG. 8, the group or department within ABC Company that proposes an entity generally performs the so-called “pre-work” phase and the activity assessment phase. The “pre-work” phase begins when a user wishing to propose a goodwill activity logs into tool 18 at a terminal 14, indicated at phase 0. The user (referred to as the “originator”) then fills out one ore more checklists 34 (presented by identification module 20) based on the various aspects of the proposed goodwill activity, as indicated at phase 1. Based on the originator's responses to checklists 34 and/or other data entered by the originator, identification module 20 identifies the type of the proposed goodwill activity (or whether the proposed activity is not classified as any type of goodwill activity, e.g., where the proposed activity is essentially a marketing expense). After the activity is identified, pre-selection criteria, such as a definition of the goodwill activity and additional mandatory criteria that must be fulfilled in order to proceed, are presented to the originator.

Next, as indicated at phase 2, the originator interacts with authorization module 22 to specify one or more other users as “co-originators” having editing rights, or “viewers” having read-only rights, to the (now identified) goodwill activity. Next, as indicated at phase 3, the originator or any co-originators specified by the originator during the authorization phase, interacts with key data module 24 to enter various key data. The entered key data may include, e.g., the recipient or beneficiary of the goodwill activity, the business entity within the larger business organization that is responsible for the goodwill activity, the monitory equivalent or other value-related information regarding the goodwill activity, etc.

Next, as indicated at phase 4, the originator or any co-originators specified by the originator during the authorization phase, interacts with assessment module 26 to assess the proposed goodwill activity. As shown in FIG. 8, the assessment phase may include a strategic assessment portion and a compliance portion. The strategic assessment portion involves collecting information from the originator/co-originator regarding the purpose and the strategic direction of the proposed goodwill activity. Assessment module 26 may present the originator/co-originator a “full scope” inquiry or a “reduced scope” inquiry based on the type and value of the particular proposed goodwill activity (e.g., the value determined during the key data collection phase 3). Based on the results of the (full or reduced inquiry), assessment module 26 may then determine one or more appropriate compliance entities for approving the proposed goodwill activity. In the compliance risk assessment portion of the assessment phase, assessment module 26 presents the originator/co-originator a set of standard compliance questions for assessing any potential compliance risks (e.g., violations of laws or business rules) associated with the proposed goodwill activity.

FIG. 9 illustrates an example approver selection matrix 130 for use during the approval of the proposed goodwill activity, indicated as phase 5. The approver selection matrix 130 (or rules defining the matrix) may be maintained and used by approval module 28 for determining the level of approval required for the proposed goodwill activity, based on the value of proposed goodwill activity. Matrix 130 defines relationships between three example value levels for the proposed goodwill activity (lower value, medium value, and higher value) and three example levels of required approval (local approver(s), local compliance entity, and company-level compliance entity).

As used herein, the term “local” in the context of “local” approvers, “local” compliance entities or officers, “local” regulations or requirements (e.g., “local” signature regulations or other “local” regulations), or other similar references to “local” entities may refer to approvers, compliance entities, and signature regulations related to a specific business entity within the larger company, which are often not limited by geographic locality.

As shown, the value level thresholds may be different for different types of goodwill activities. In addition, in this example, hospitality packages with a value above 25,000 Euros are classified as “higher value” activities, but hospitality packages with a value above 25,000 Euros are subject to local regulations and outside the scope of tool 18. It should be understood that the threshold values shown in FIG. 9, along with all other values disclosed herein, are examples only.

Further, depending on the particular embodiment, some or all threshold values may be altered by an authorized administrator (e.g., as discussed below with reference to 44). For example, in this embodiment, the threshold values for requiring approval by the local compliance entity (i.e., the minimum values of 5,000 Euros and 1,000 Euros shown in the “Medium Value” box) may be reduced (but not increased) for each activity type and for each business entity, by an authorized administrator for the relevant business entity.

As shown in the example embodiment of FIG. 9:

“Lower Value” activities must be approved by:
(1) one or more local approvers, according to the local signature regulation, and
(2) the local compliance entity (e.g., the local compliance officer or deputy compliance officer) only if: (a) any danger sign questions were answered “yes” during the compliance risk assessment (assessment phase 4) or (b) if required by the local signature regulation.

“Medium Value” activities must be approved by:
(1) one or more local approvers, according to the local signature regulation, and
(2) the local compliance entity (e.g., the local compliance officer or deputy compliance officer).

“Higher Value” activities must be approved by:
(1) one or more local approvers, according to the local signature regulation, and
(2) the local compliance entity (e.g., the local compliance officer or deputy compliance officer), and
(3) a responsible person from ABC Company's company-level compliance entity (e.g., an authorized member of a corporate communications group).

FIG. 10 illustrates an example screenshot from the post-approval activity execution phase, according to certain embodiments. The execution section becomes visible only after the activity has been approved. The execution phase offers the possibility to upload and document additional information concerning the execution and measurement of the activity. For sponsoring and hospitality packages the completion of the execution phase is mandatory. However, also for other contributions the completion of this phase might be necessary depending on local regulations (e.g., upload of donation receipts). In addition, an approval voucher for the activity is available in this phase in order to ensure that contributions are booked to correct accounts with a reference to the identification number assigned to the goodwill activity by tool 18.

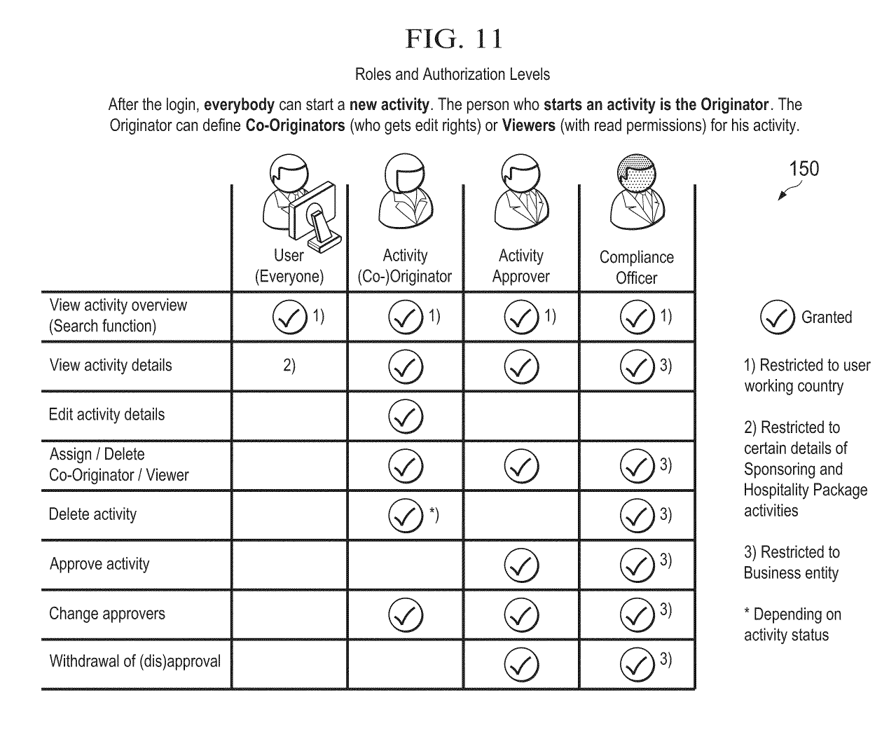

FIG. 11 illustrates an example matrix 150 of roles and authorization levels defined by tool 18 for different people involved in the goodwill activity evaluation process, according to certain embodiments. After logging in, any user of tool 18 can start a new proposed goodwill activity, which makes that use the activity “originator.” As discussed above, the originator can specify one or more “co-originators” (who get edit rights to the proposed activity) and/or “viewers” (who get read only rights to the proposed activity).

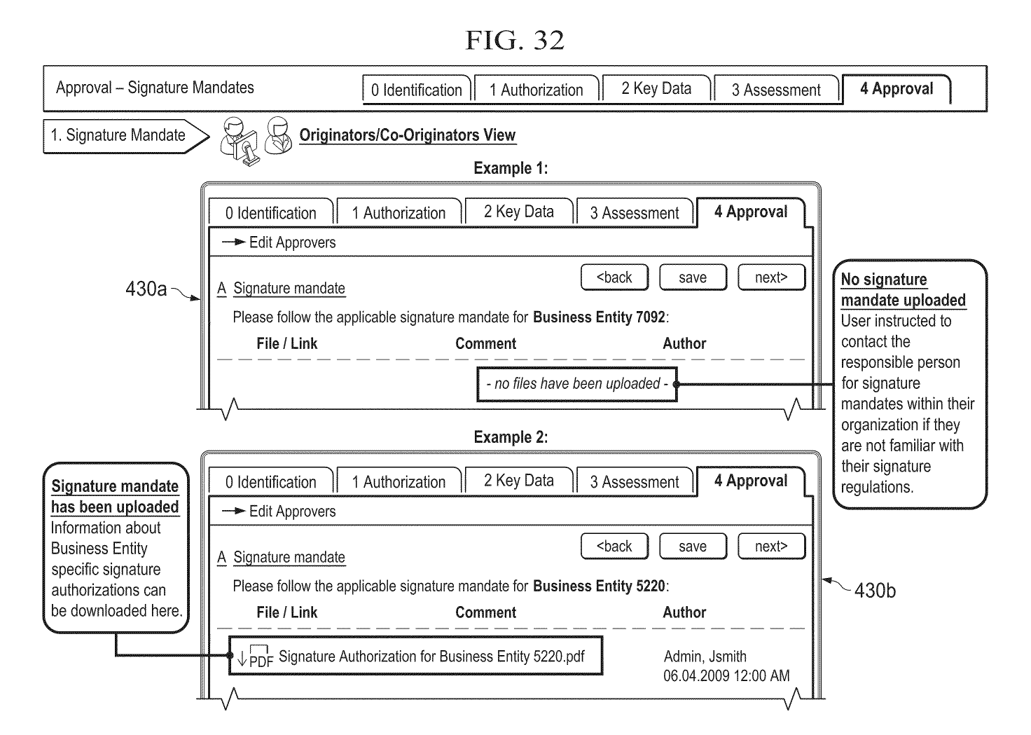

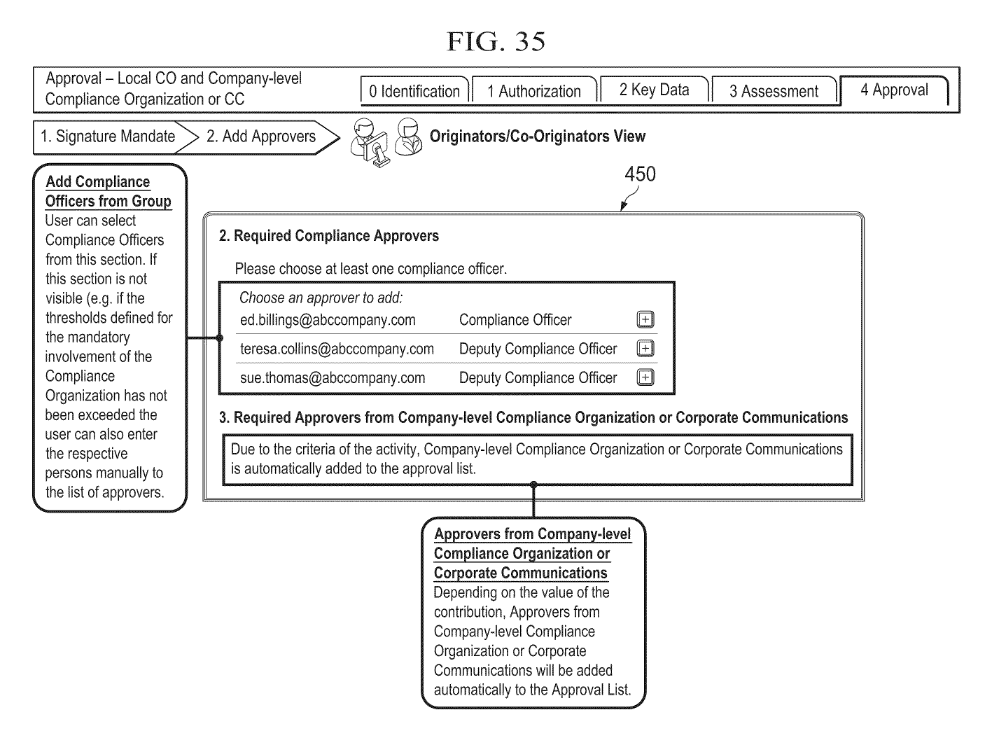

As shown in matrix 150, the activity originator and co-originators (if any) are authorized for all functions except approving the proposed activity, and withdrawing an approval or disapproval of the proposed activity. An activity approver (identified or selected during the beginning of the approval phase, as discussed below with reference to FIGS. 32-34) is authorized for all functions except editing details of the proposed activity, and deleting the proposed activity. A compliance officer (identified or selected during the beginning of the approval phase, as discussed below with reference to FIG. 35) is authorized for all functions except editing details of the proposed activity. As discussed herein, in some embodiments, a compliance officer is involved in the activity approval process if either (a) the value of the activity is above a corresponding predetermined threshold value, or (b) any compliance risk danger question is answered in the positive by the originator/co-originator.

As shown in matrix 150 (indicated by note 1), each user's access to view activities via a search function is restricted to activities originated in the same country as that user. Further (indicated by note 2), only the originator, co-originators, approvers, and compliance officer specified for a sponsoring or hospitality package activity have access to view all details of the activity; all other users have restricted access to view only certain details of the activity. Further (indicated by note 3), a compliance officer's authority is generally limited to activities within the compliance officer's specific business entity.

### Example Embodiment of Goodwill Activity Management Tool 18

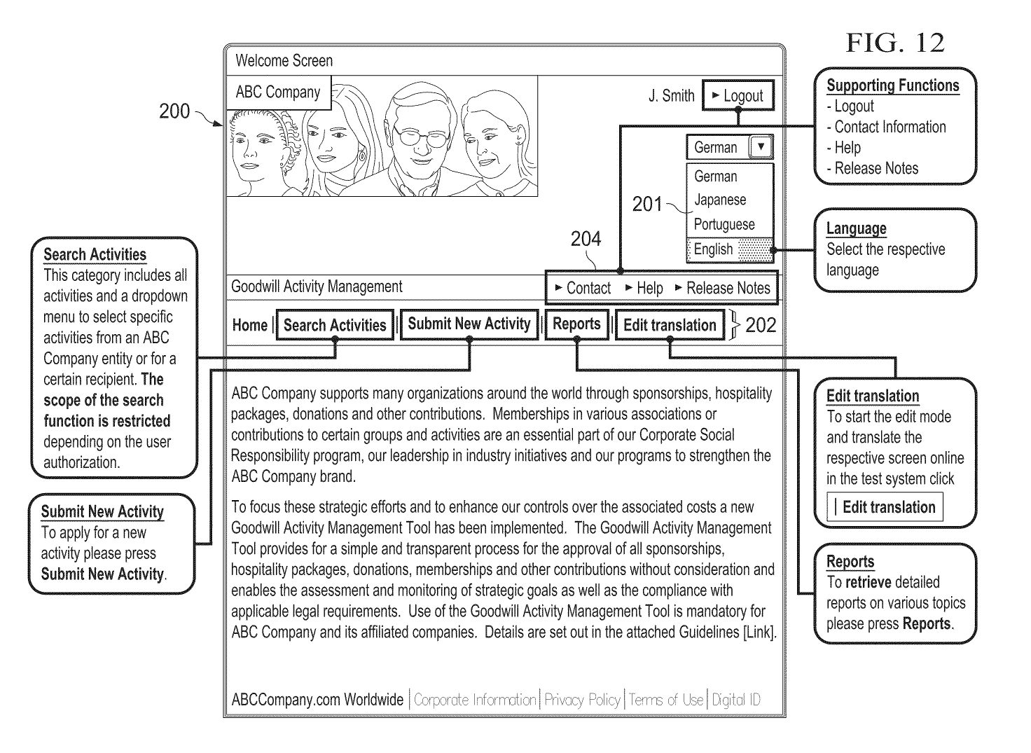

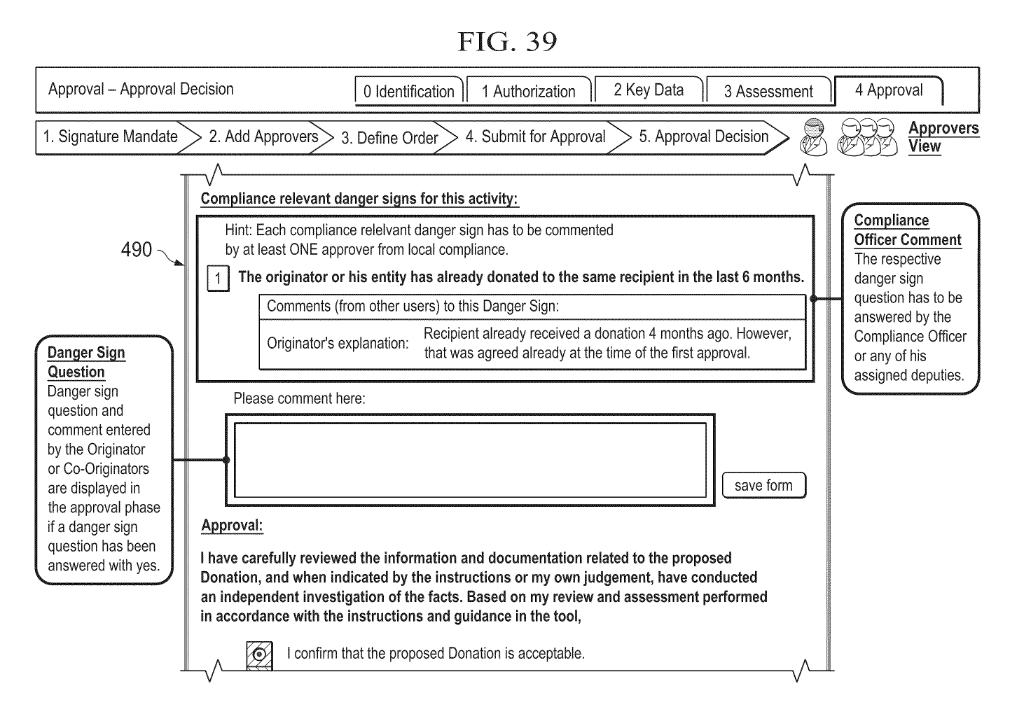

FIGS. 12-50 illustrate screenshots and other relevant data for one example embodiment of goodwill activity management tool 18. The illustrated screenshots are generated by the various modules of tool 18 discussed above and presented to users at terminals 14, thus allowing the users to interact with tool 18.

FIG. 12 illustrates an example welcome (or “home”) screen 200 for tool 18. As shown, the welcome screen includes a menu 201 for selecting the default language, selectable buttons 202 for selecting major functions of Search Activities, Submit New Activity, Reports, and Edit Translation, as well as selectable buttons 204 for selecting supporting function of Logout, Contact Information, Help, and Release Notes.

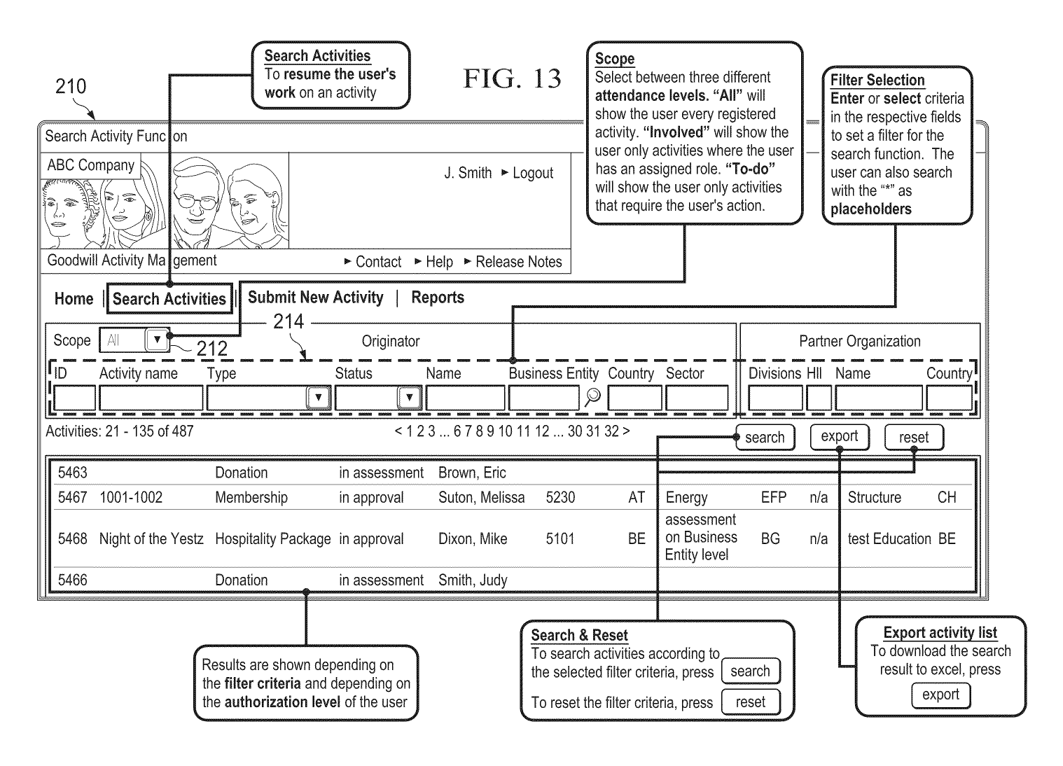

FIG. 13 illustrates an example screenshot 210 from the Search Activity function. A “Scope” selector 212 allows the user to select between three different attendance levels: All, Involved, and To-do, which are described in FIG. 13. A “Filter” selector allows the user to enter or select desired filter criteria for the search. A “Search” button allows the user to initiate the search based on the selected scope and filter criteria. The search results are then displayed at the bottom, with the results depending on the selected scope and filter criteria, and the authorization level of the user. A “Reset” button for resetting the filter criteria, and an “Export” button for downloading the search results to a spreadsheet (e.g., EXCEL) or other file, are also provided.

The authorization level of the user and the selected activity influence the displayed search results. A “standard user” has full access to his/her own activities. In the search list, he/she can view further activities without having access to activities' details. This includes all activities worldwide concerning sponsoring and hospitality packages. For all other types (e.g., donations), the search is restricted to activities in the user's country. Compliance officers and deputy compliance officers have full access to all activities in each business entity for with they are assigned according to assignments maintained by tool 18.

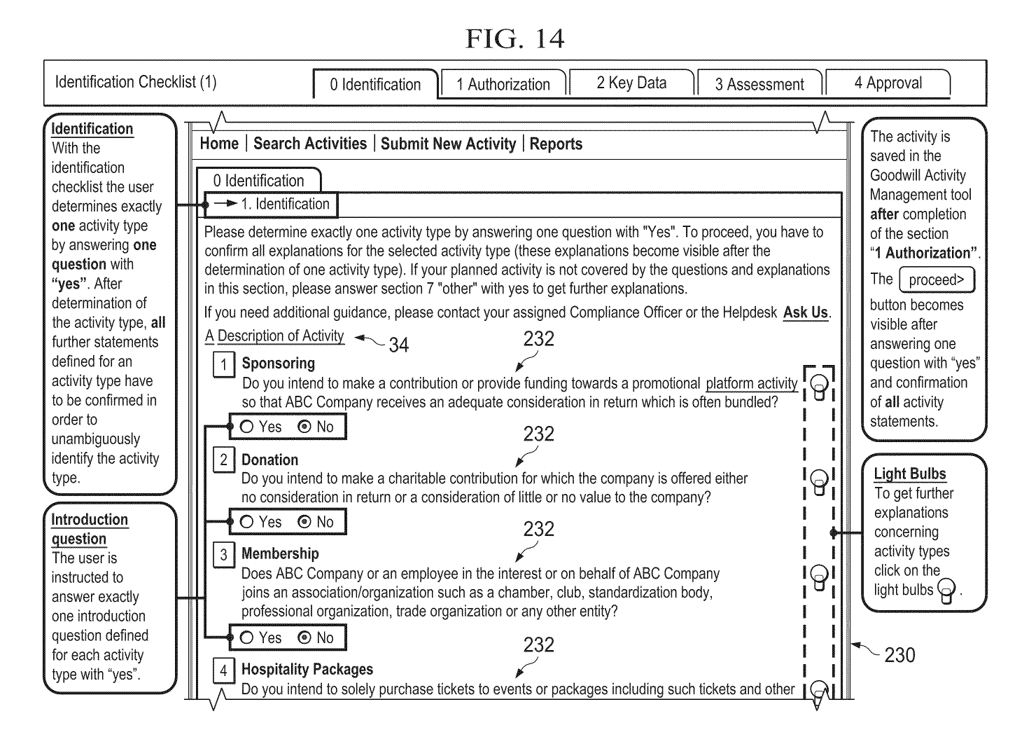

FIGS. 14-41 illustrate screenshots and other functionality related to the submission and evaluation of an example new activity proposed by a user, User A. As discussed above, the first phase of the process is the activity identification phase. FIGS. 14-18 illustrate screenshots and other functionality related to the activity identification phase of the evaluation process. Thus, such functionality may be provided by identification module 20, with access to checklists 34 and rules 35.

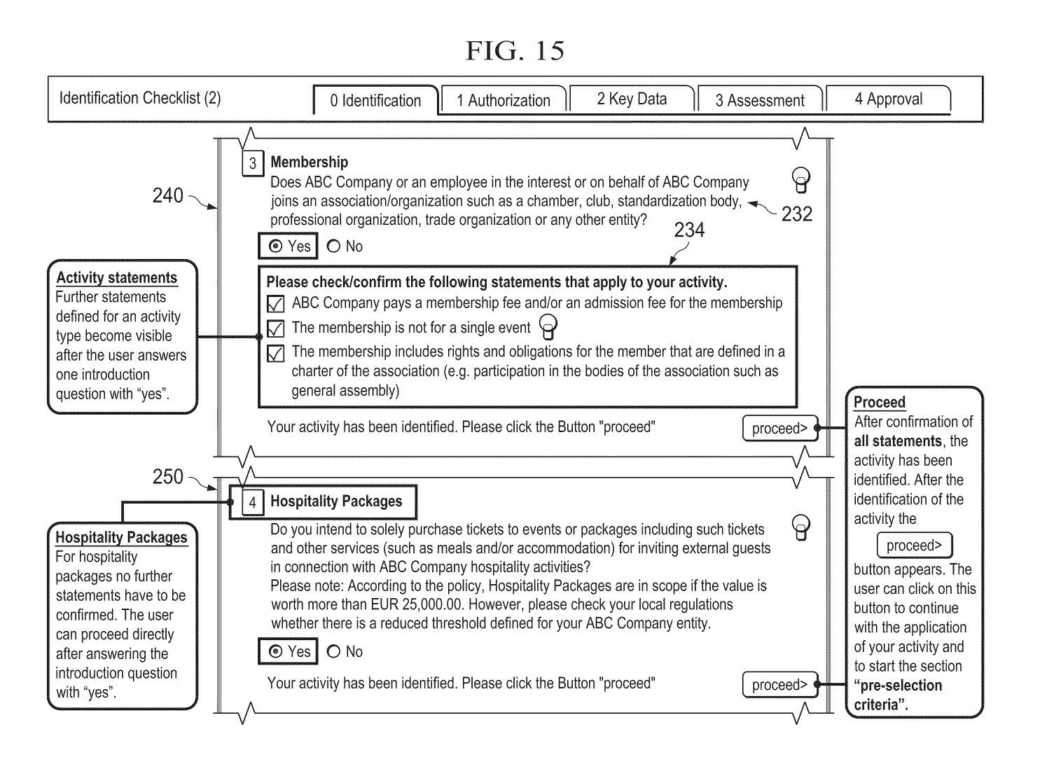

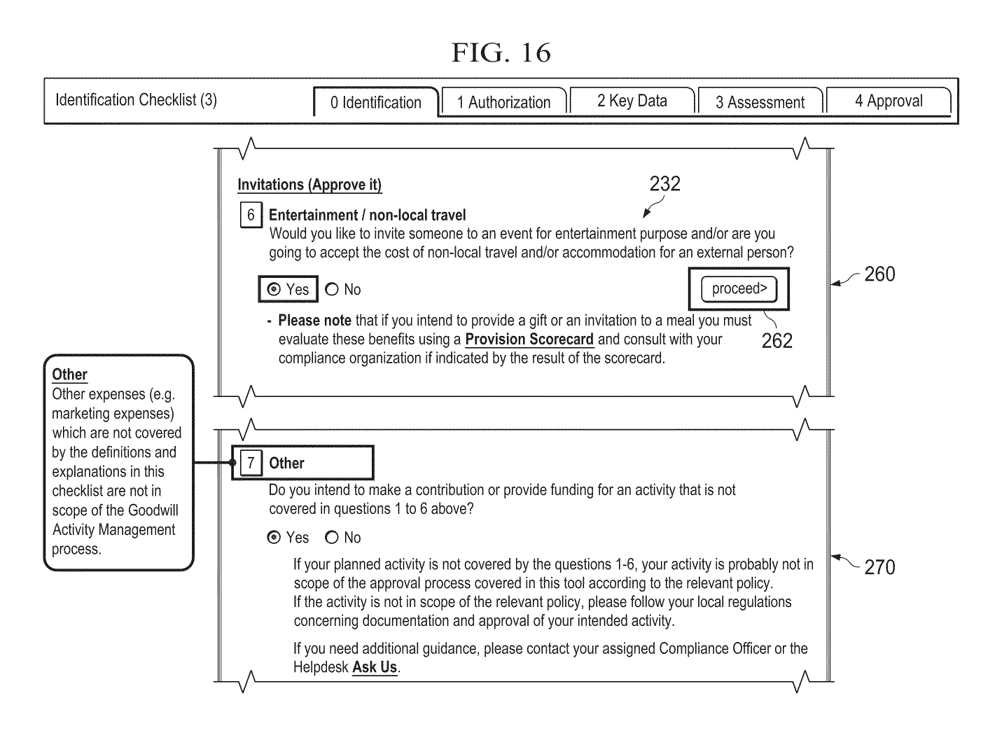

FIG. 14 illustrates an example screenshot 210 displaying a portion of an example identification checklist 34. The purpose of the identification checklist 34 is to unambiguously categorize the activity type. The identification checklist 34 consists of one introduction question 232 for each activity type. The user is instructed to answer exactly one of these questions with “yes.” FIGS. 15 and 16 illustrate example partial screenshots indicating the result of selecting “yes” for different activity types.

When the user answers “yes” to the introduction question corresponding to certain activity types (e.g., sponsoring, donation, and membership activity types), a set of activity type confirmation statements 234 specific to the selected activity types become visible. For example, the partial screenshot 240 in the upper portion of FIG. 15 illustrates a set of activity type confirmation statements 234 specific to the “membership” activity type become visible when the user clicks “yes” for the “membership” introduction question. After answering all of the confirmation statements 234, a “proceed” button appears, which the user may then click to advance to the “pre-selection criteria” portion of the identification phase.

The activity type confirmation statements 234 for each activity type may correspond to the rules 35 maintained by identification module 20 for that activity type. Thus, for example, the activity type confirmation statements 234 displayed to the user may correspond to the example rules 35 discussed above.

As shown in the partial screenshot 250 in the lower portion of FIG. 15, for hospitality packages, no activity type confirmation statements are needed. The user can proceed directly after answering “yes” to the “hospitality packages” introduction question 232.

Note that if the user's proposed activity is not covered by the questions and explanations in the identification checklist 34, the activity is probably outside the scope of the evaluation and approval process managed by tool 18.

As shown in the partial screenshot 260 in the upper portion of FIG. 16, an introduction question 232 is provided for “invitation” type activities (i.e., invitations of external guests to entertainment or other events, and non-local travel expenses for such guests). If the user selects “yes” to introduction question 232 and clicks link 262 to proceed, tool 18 routes the user to invitation approval tool 38, for an evaluation/approval process specific to invitation type activities. As discussed above, invitation approval tool 38 may be part of, or separate from (but configured to interact with) tool 18. The evaluation/approval process for invitation type activities is discussed in greater detail below with reference to FIGS. 53-61.

As shown in the partial screenshot 270 in the lower portion of FIG. 16, other expenses (e.g., marketing expenses) that are not covered by the definitions and explanations in identification checklist 34 and outside the scope of the process managed by tool 18. For such activities, the user is directed to follow local regulations regarding documentation and approval of the activity.

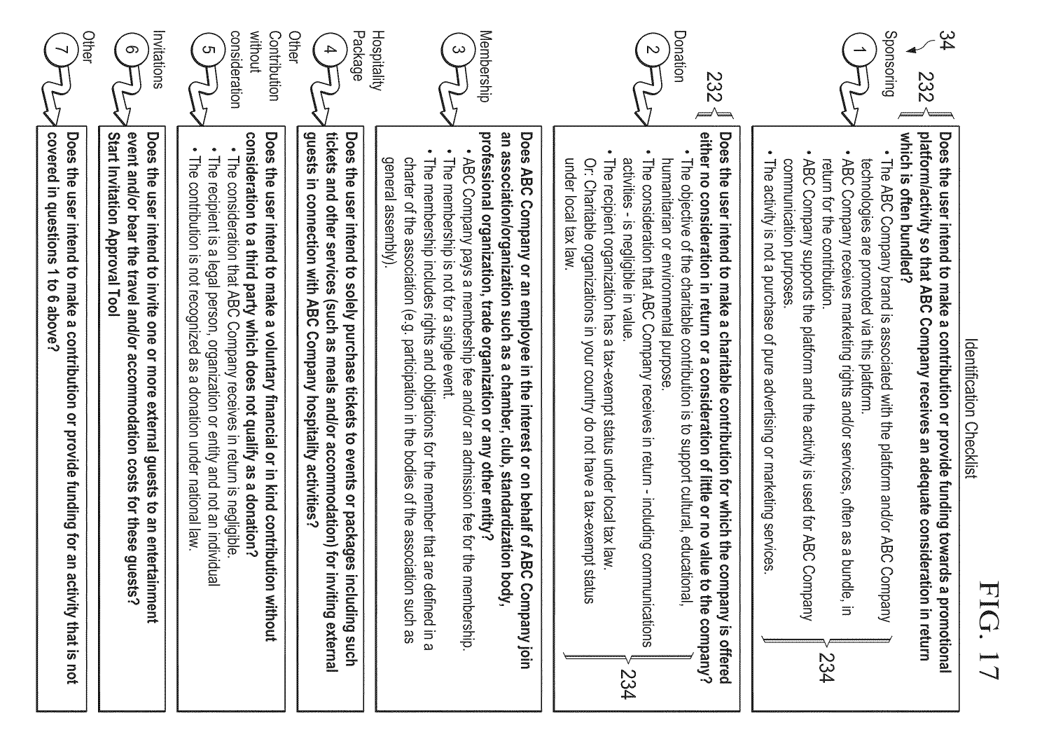

FIG. 17 illustrates an example identification checklist 34, including introduction question 232 for each activity type, and activity type confirmation statements 234 for certain activity types.

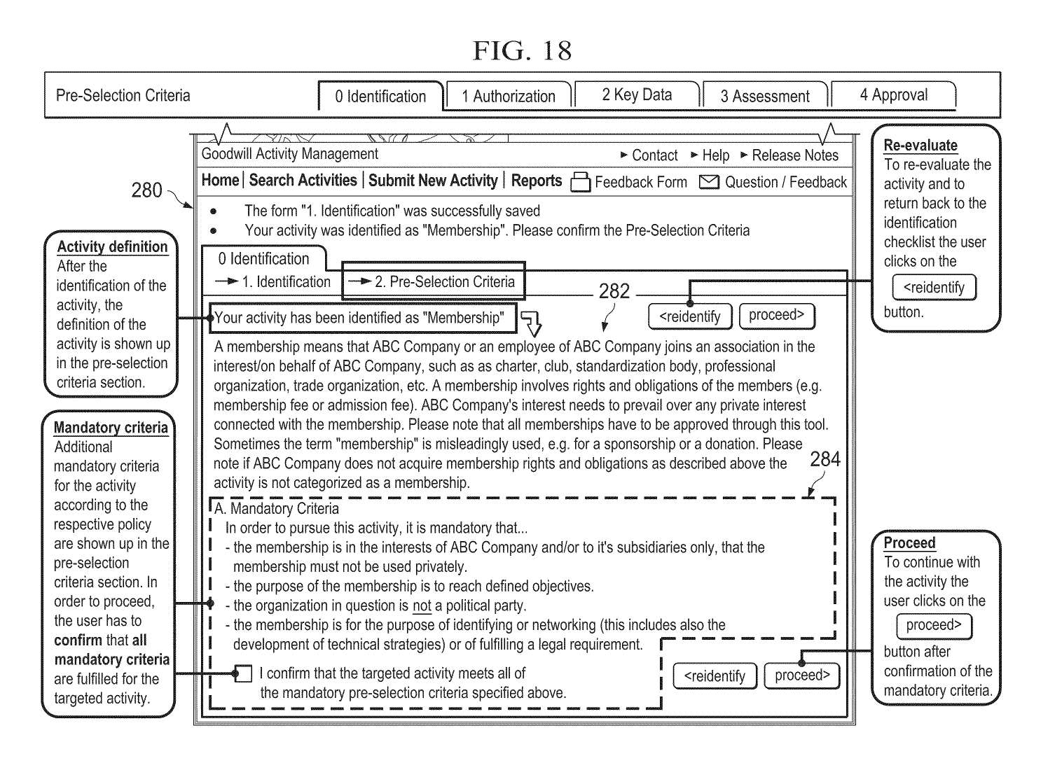

FIG. 18 illustrates an example screenshot 280 from the pre-selection criteria portion of the activity identification phase. After the identification of the proposed activity, identification module 20 displays a definition 282 of the activity and additional mandatory criteria 284. The user must confirm that all mandatory criteria 284 are fulfilled in order to proceed. In addition, for sponsoring and hospitality packages, other criteria are defined which may influence the approval decision of the activity. A “reidentify” button is also provided for returning to the identification checklist to re-evaluate the activity.

FIG. 19 illustrates an example screenshot 290 from the authorization phase of the process. This functionality may be provided by authorization module 22. As discussed above, in the authorization phase, the activity originator can specify one or more “co-originators” (who get edit rights to the proposed activity) and/or “viewers” (who get read only rights to the proposed activity). Specifically, the originator can select “COORIGINATOR” or “VIEWER” from a drop-down menu and then either manually specify a co-originator or viewer (e.g., by entering the email address), or clicking a magnifying glass icon to open a selectable list of possible co-originators/viewers. Once the originator has specified all co-originators and/or viewers as desired, the originator clicks an “initialize” button to proceed, which automatically saves the activity and generates a unique activity ID number that is stored by tool 18.

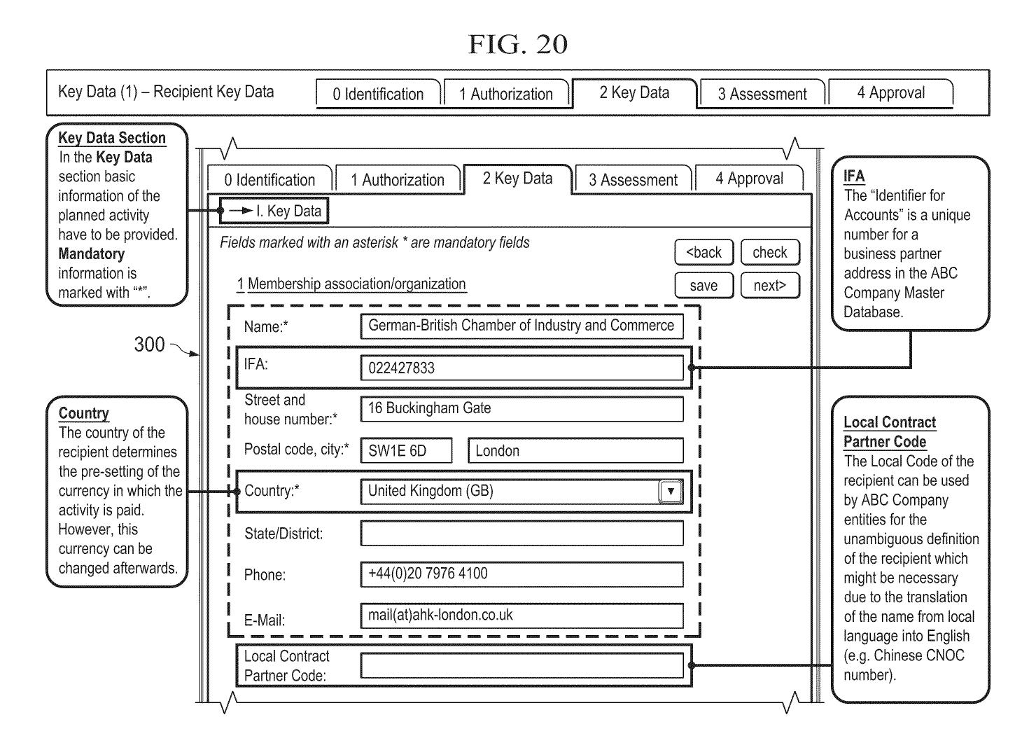

FIGS. 20-23 illustrate example screenshots and other functionality related to the key data phase of the evaluation process. Thus, such functionality may be provided by key data module 24. FIG. 20 illustrates an example screenshot 300 for a process for finding a matching recipient (if any) for the proposed activity. The first step in the key data phase is to enter the recipient of the proposed activity. To avoid double entries and facilitate the search of existing recipients, a real-time search engine is provided for searching recipients that have previously been entered into tool 18. If the recipient is not found in the search engine, the user must manually enter the relevant data regarding the activity recipient, as shown in FIG. 20. In some embodiments, the real-time search engine may be operable to identify one or more recipient names matching a partial name in real time as the user types in the name to be searched. For example, if the user has entered a partial name and the real-time search engine finds a match, tool 18 may automatically fill in the remaining portion of the name, e.g., in highlighted text. If the user has entered a partial name and the real-time search engine finds multiple possible matches, tool 18 may automatically provide a dropdown menu of such possible matches for the user to select from.

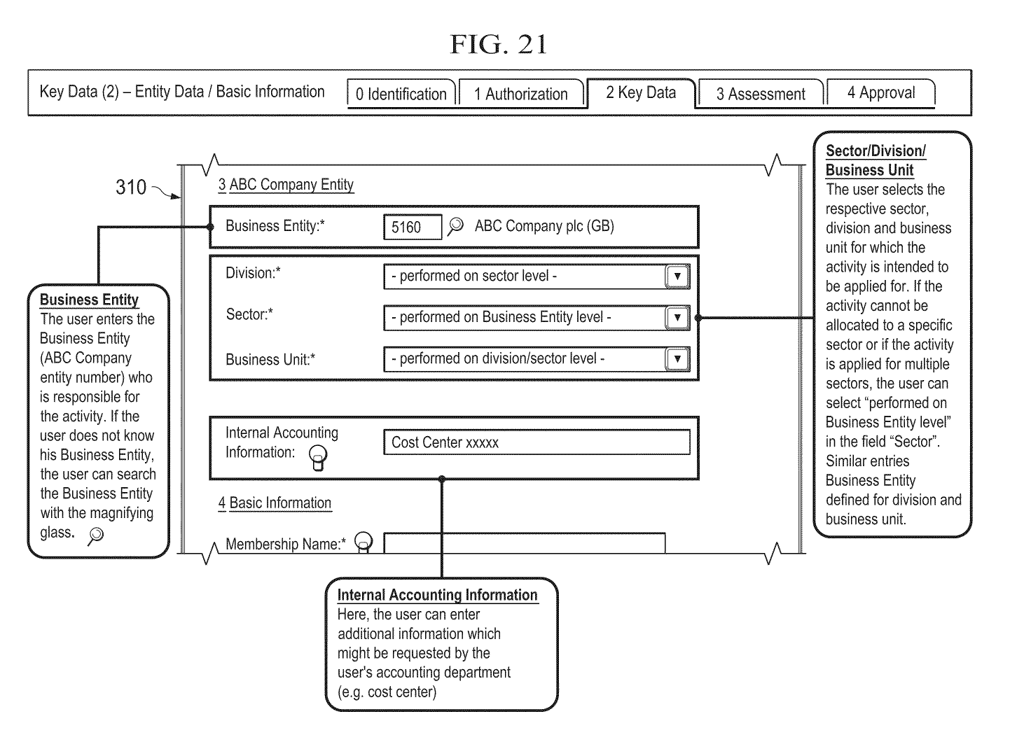

FIG. 21 illustrates an example screenshot 310 for facilitating entry of the business entity and sector, division, and/or business unit within ABC Company that is responsible for the proposed activity. For such data entry, key data module 24 may provide various drop-down lists and or fields for entering ID numbers or other identifying information. As discussed herein, the selected business entity determines the corresponding compliance officer entity and, if maintained, specific approver groups (e.g., consisting of local management and/or local communications department personnel) which may be involved in the approval process. In addition, business entity specific process descriptions and signature regulations can be uploaded in tool 18.

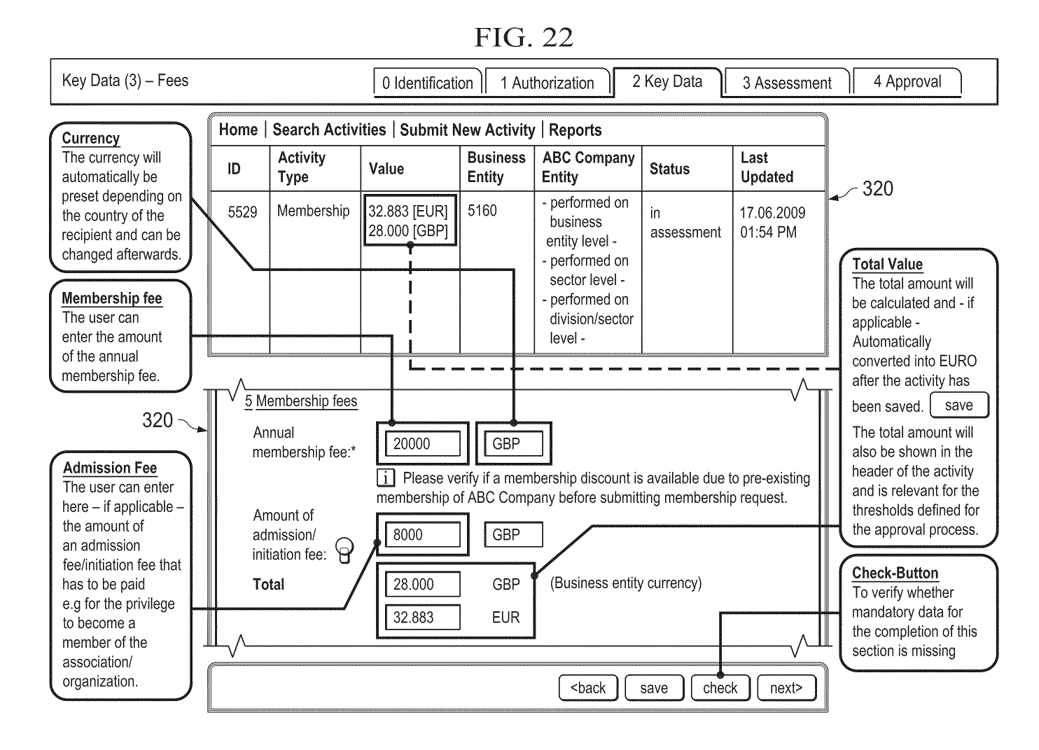

FIG. 22 illustrates example screenshot portions 320 for facilitating entry of the monitory equivalent of the contribution involved in the proposed activity, where the proposed activity is a membership. The total value of the activity is calculated by key data module 24 after the activity has been saved, the value being relevant for the thresholds defined for the approval process (e.g., as discussed above regarding FIG. 9).

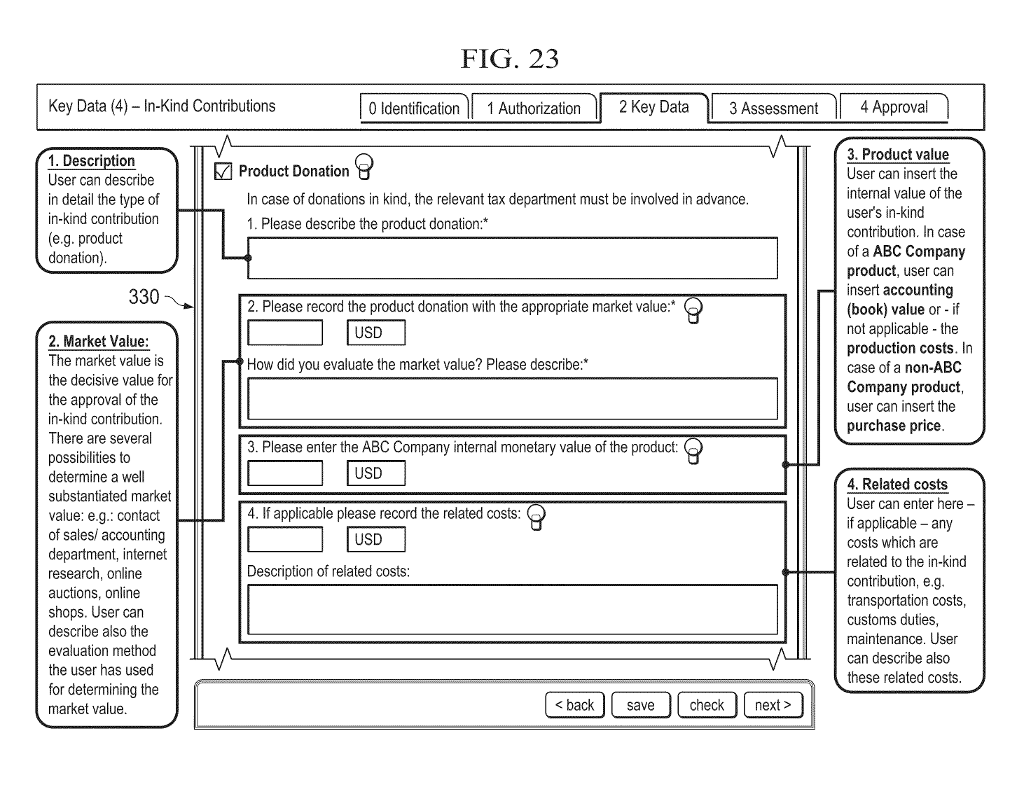

FIG. 23 illustrates an example screenshot 330 for facilitating entry of additional information regarding the monitory equivalent of in-kind contributions (e.g., product donations or other contributions without consideration).

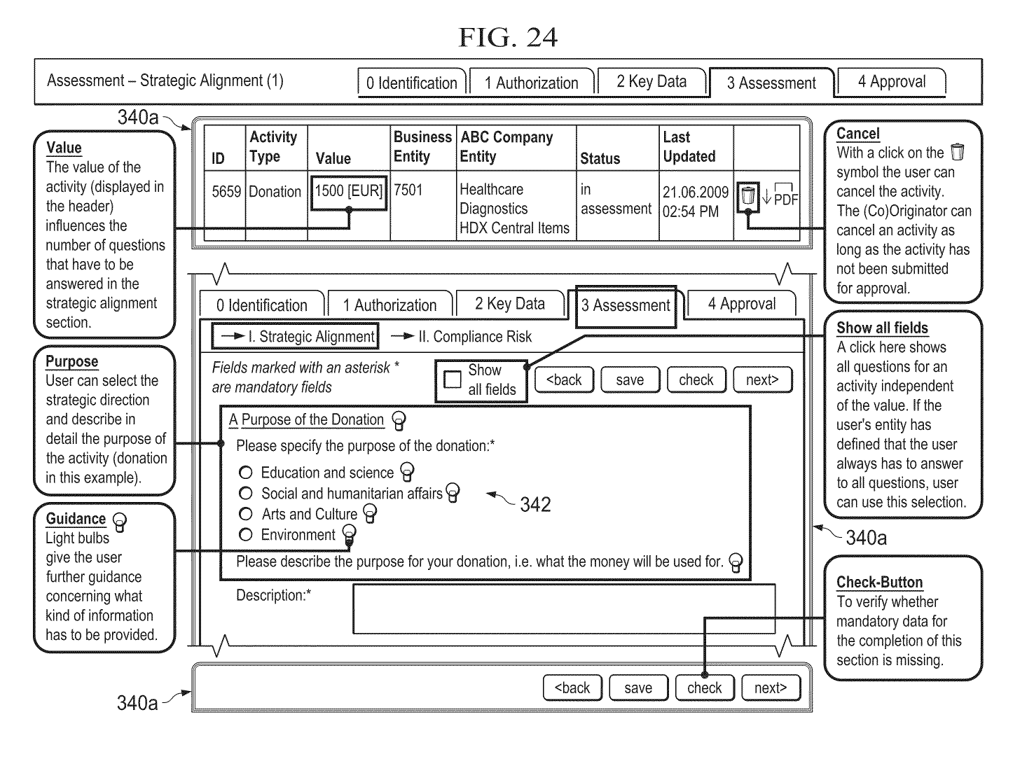

FIGS. 24-29 illustrate example screenshots and other functionality related to the assessment phase of the evaluation process. Thus, such functionality may be provided by assessment module 26. As discussed above, the assessment phase includes a strategic alignment portion and a compliance risk assessment portion.

FIGS. 24-27 illustrates example screenshots from the strategic alignment portion of the assessment phase. In the strategic alignment portion of the assessment phase, information concerning the purpose and strategic direction of the activity are entered into tool 18. The type of activity, as well as the value of the activity (as determined by key data module 24), influence the number and/or type of questions that are presented to the user.

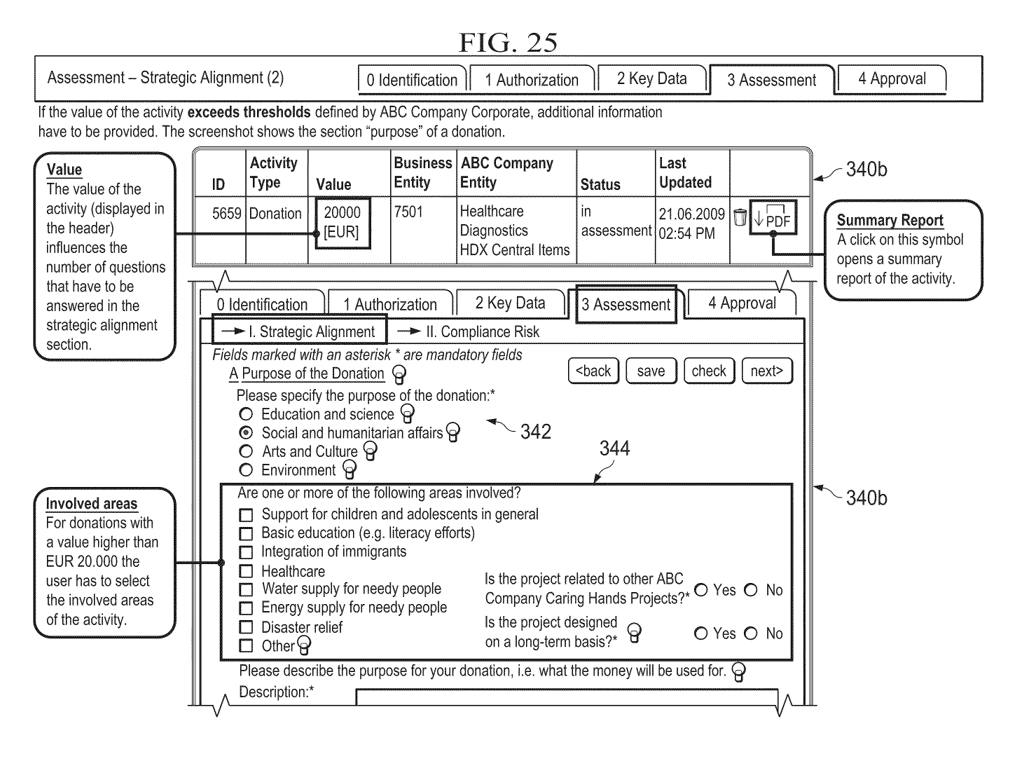

FIG. 24 illustrates example screenshot portions 340a showing strategic alignment questions for a donation type activity. In this example, the donation value (1500 Euros, as indicated in a header section of screenshot 340a) is below a predefined threshold stored by assessment module 26, and thus a basic question or set of questions 342 is presented to the user. In contrast, FIG. 25 illustrates example screenshot portions 340b wherein the donation value (20,000 Euros) is above the predefined threshold, and thus a set of additional questions 344, in addition to the basic question 342, is presented to the user. Assessment module 26 may store one or more threshold values for different activity types, which are compared against the value of the proposed activity for automatically selecting the number and/or type of questions that are presented to the user.

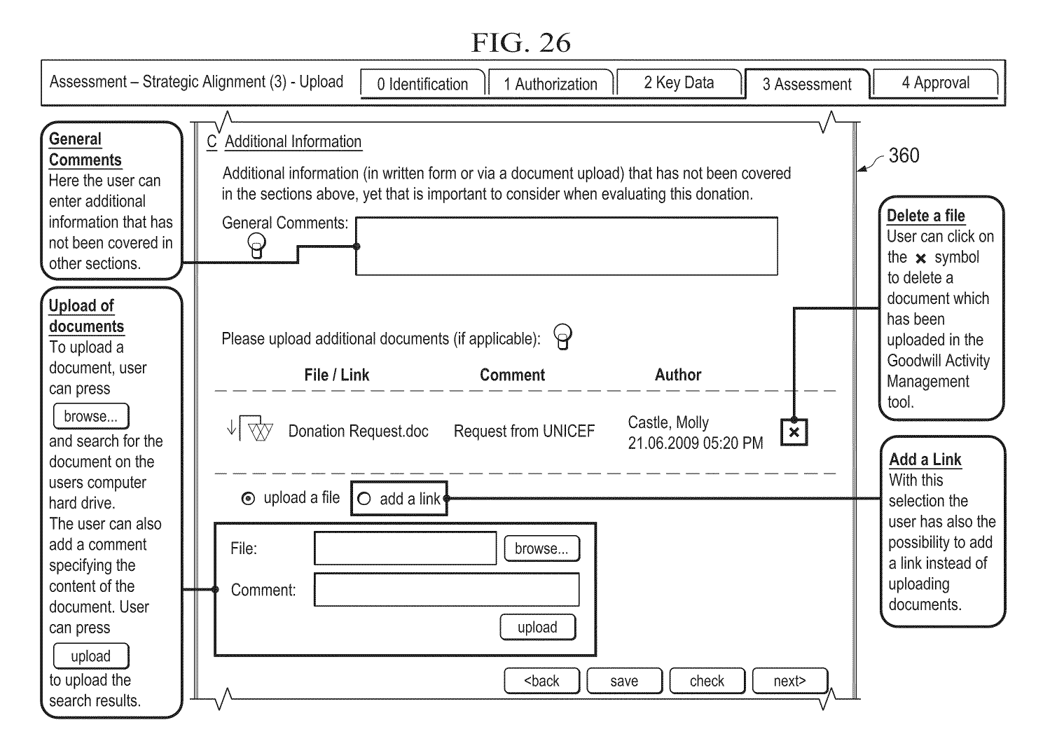

FIG. 26 illustrates an example screenshot 360 for facilitating the uploading of documents and/or providing comments related to the proposed activity, which may be useful to those involved in the approval process.

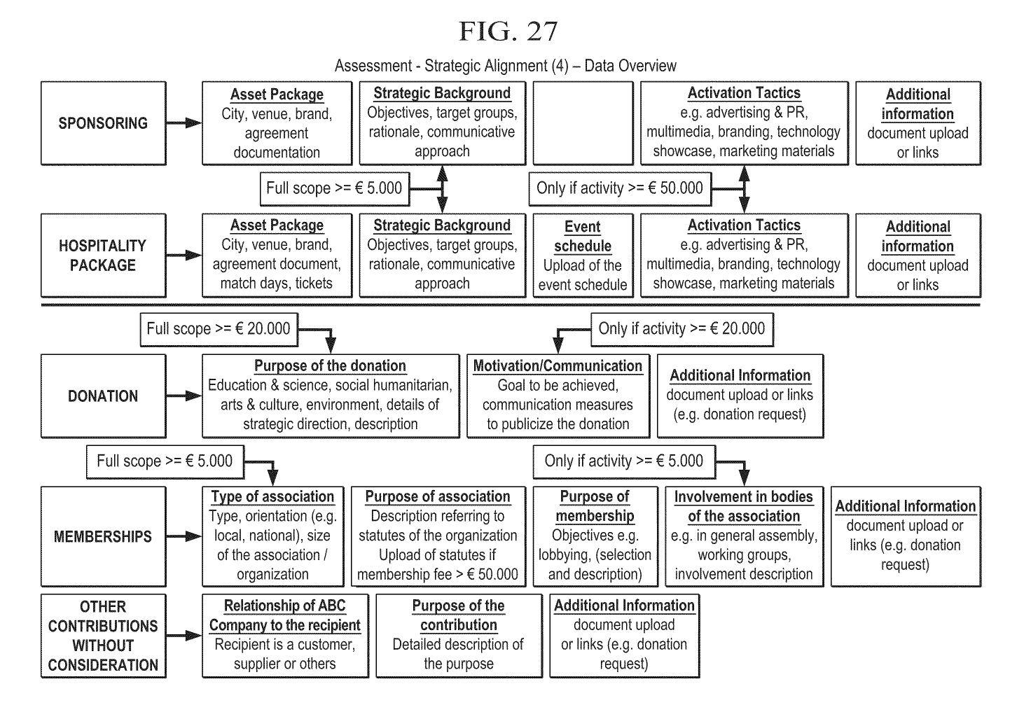

FIG. 27 illustrates an example overview for the strategic alignment portion of the assessment phase, indicating the flow of information collection facilitated by assessment module 26 based on (a) the activity type and (b) the value of the activity. In this example, each box represents a collection of information, e.g., a questionnaire or other data input prompts presented to the originator/co-originator. Boxes labeled “Full scope>=[threshold monetary value]” indicate areas in which different scopes of information collection are required based on the value of the activity being analyzed. For example, regarding either of the “Strategic Background” boxes with the corresponding “Full scope>= [symbol] 5,000” label, tool 18 may require the originator/co-originator to complete a first questionnaire if the value of the activity is less than [symbol] 5,000, and alternatively, a second, more comprehensive questionnaire if the value of the activity is greater than or equal to [symbol] 5,000.

Boxes labeled “Only if activity>=[threshold monetary value]” indicate areas in which information collection is required only if the value of the activity being analyzed exceeds the threshold monetary value. For example, regarding either of the “Activation Tactics” boxes with the corresponding “Only if activity>= [symbol] 50,000” label, tool 18 may require the originator/co-originator to complete a questionnaire only if the value of the activity is greater than or equal to [symbol] 50,000. Otherwise, tool 18 may not require information collection regarding this area.

For each box not labeled as either “Full scope>=[threshold monetary value]” or “Only if activity>=[threshold monetary value]”, tool 18 requires a defined scope of information collection that is not dependent on the value of the activity.

In some embodiments, an authorized user may define and/or modify which specific information collection areas have a scope of information collection dependent on the value of the activity. For example, an authorized user may define and/or modify which specific information collection areas are designated as (a) “Full scope>=[threshold monetary value]”, (b) “Only if activity>=[threshold monetary value]”, or (c) neither. In addition, an authorized user may define and/or modify the threshold monetary values for each information collection area in which the scope is dependent on the value of the activity. Thus, the details of the information collection process facilitated by assessment module 26 may be defined and/or modified as desired, such that the process is substantially flexible.

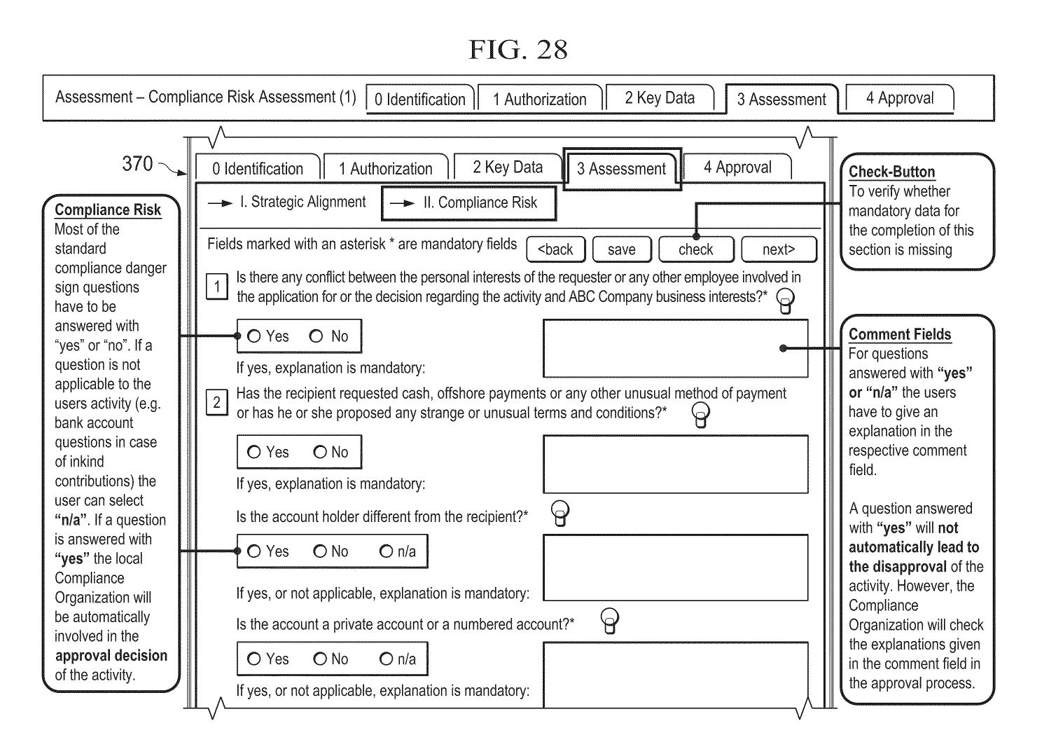

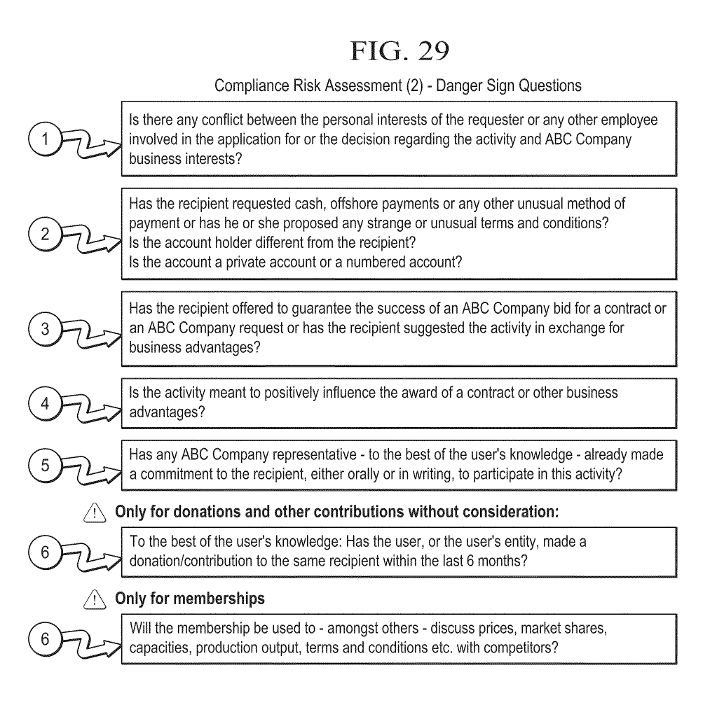

FIG. 28 illustrates an example screenshot 370 from the compliance risk assessment portion of the assessment phase. In the compliance risk assessment portion, compliance related danger sign questions concerning the proposed activity are presented to the user, as shown in FIG. 28. If a danger sign question is answered “yes”, assessment module 26 includes the relevant local compliance organization in the approval decision, regardless of any value thresholds. FIG. 29 illustrates a list of example compliance danger sign questions to be answered by the user.

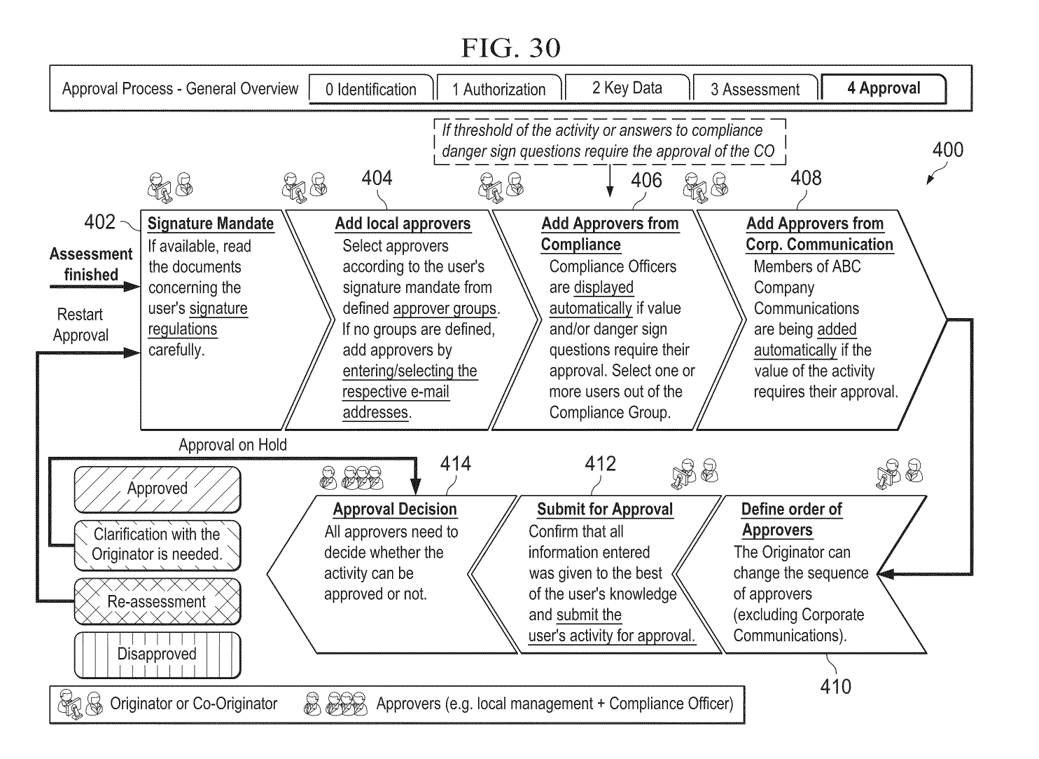

FIGS. 30-39 illustrate example screenshots and other functionality related to the approval phase of the evaluation process, according to certain embodiments. Thus, such functionality may be provided by approval module 28. FIG. 30 illustrates a general overview 400 of the approval process, according to one embodiment. The general overview illustrates the various steps of the process flow, and which persons are responsible for performing each step. Specifically, the originator or co-originator is responsible for performing the following steps: signature mandate (402), add local approvers (404), add approvers from compliance (406), add approvers from corporate communication (408), (e) define order of approvers (410), and submit for approval (412). The approvers (e.g., local management and compliance officer) are then responsible for the approval decision (414).

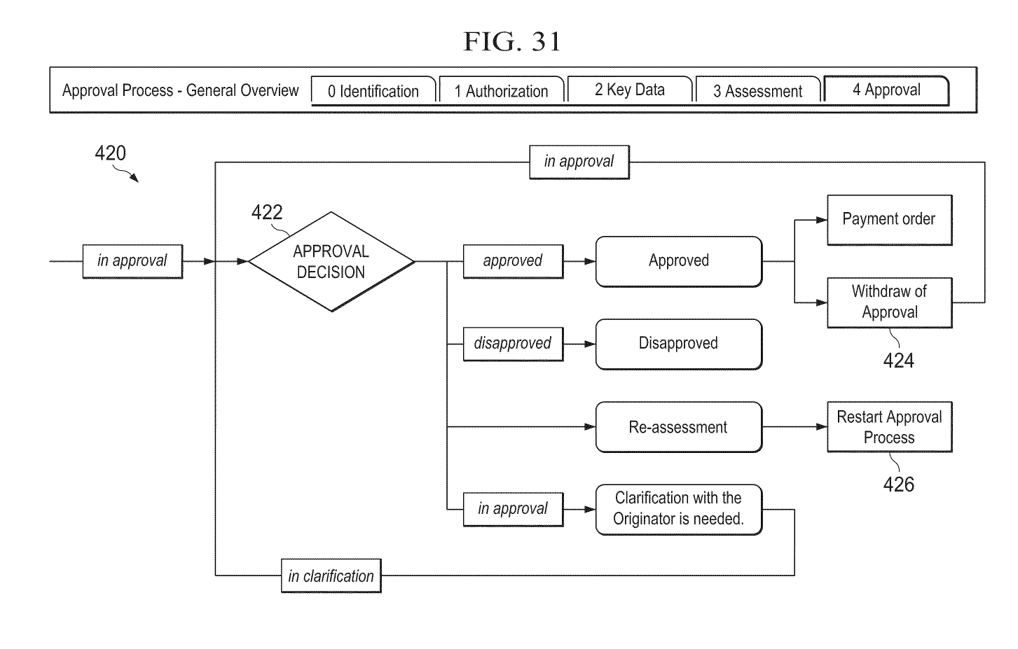

FIG. 31 illustrates a flow chart 420 of the approval decision process. As shown, at decision step 422, the approver(s) can (a) approve the activity, (b) disapprove the activity, (c) request clarification of one or more aspects of the activity from the activity originator, or (d) require a re-assessment of the whole activity, i.e., a restart of the approval phase. If the activity is approved, the approver(s) can subsequently withdraw the approval, indicated at 424 (e.g., if new information has become available), and the activity can either be sent back to the originator or a different approval decision can be made by the approver(s).

If an approver requests a clarification from the originator, the approval process is put on hold in status “in clarification,” as shown in FIG. 31. Any existing approvals are not affected/withdrawn. After making the required changes, the originators submits the activity back to the approver requesting the clarification, and each other approver is notified about any changes in the submitted activity.

If an approver requires a re-assessment of the activity, all existing approvals (if any) are withdrawn, and the approval process is fully restarted, as shown at 426.

With reference to process flow 400 shown in FIG. 30, for the “signature mandate” step 402, approval module 28 allows uploading of local signature mandates to facilitate the selection of approvers by the originator/co-originator. These documents can be uploaded either by the compliance officer who is responsible for the relevant business entity of ABC Company or by administrators nominated by the compliance officer. Signature regulations can be uploaded for each business entity and activity type. Approval module 28 also allows addition of a link to signature regulations defined for the respective business entity and activity type.

FIG. 32 illustrates example partial screenshots 430a and 430b (originator's/co-originator's view) from the signature mandate step 402. Screenshot 430a Screenshot 430a represents Example 1, the situation in which no signature mandate has been uploaded for the particular business entity and activity type corresponding to the proposed activity. Screenshot 430b represents Example 2, the situation in which a signature mandate has been uploaded for the particular business entity and activity type corresponding to the proposed activity. In the case of Example 2, the originator/co-originator can download the signature mandate from tool 18, as shown.

Regarding the “add local approvers” step 404, approval module 28 allows compliance officers and administrators of a business entity to define one or more approver groups for an activity and to add persons to these groups, such that the originator/co-originator can select one or more approvers from these group(s). Approval module 28 allows compliance officers/administrators to define value thresholds for each approver group in order to ensure that value based signature regulations for a business entity are adhered to. Approval module 28 may also allow compliance officers/administrators to define a minimum number of approvers to be selected from each approver group (e.g., as specified in the relevant signature mandates).

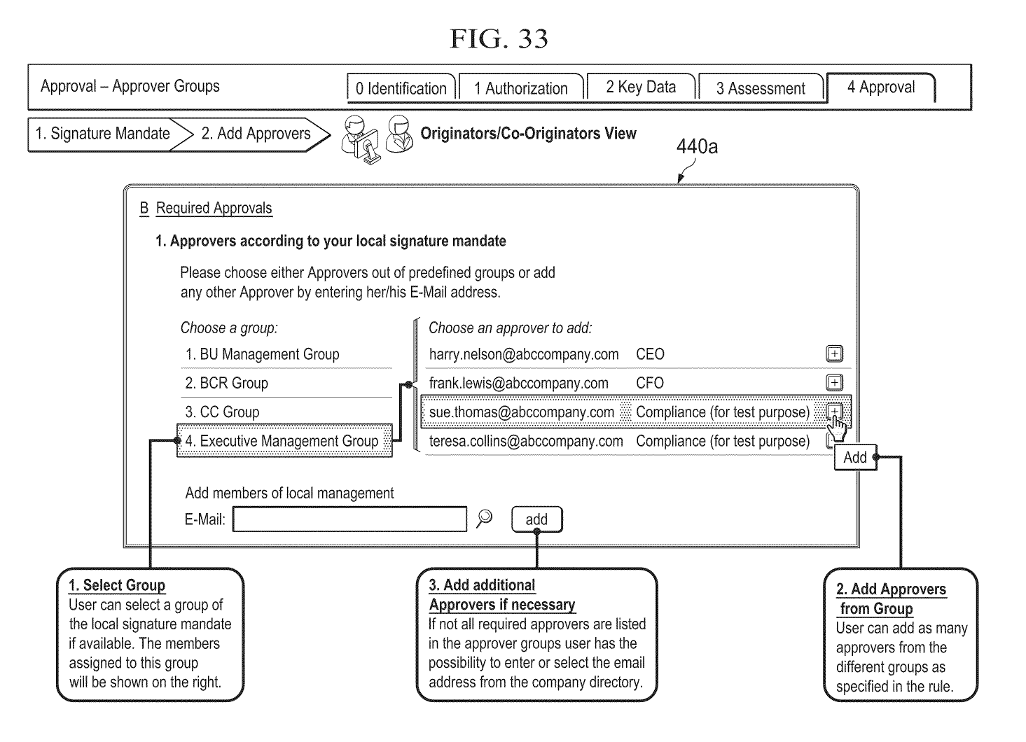

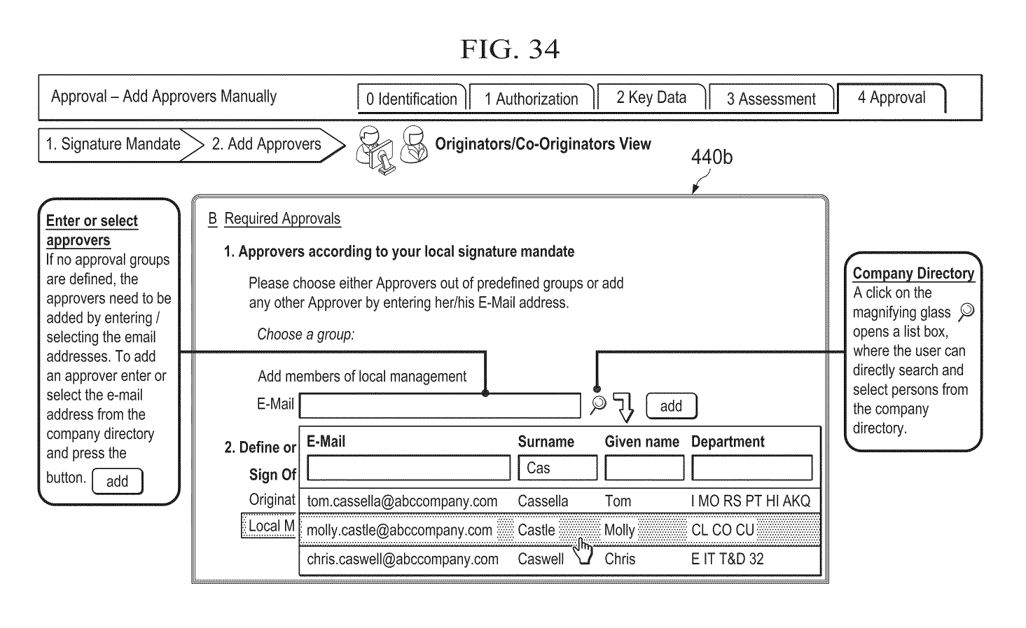

FIG. 33 illustrates an example screenshot 440a presented to originator/co-originator for selecting an approver group and then selecting one or more approvers from the selected approver group. The number of approvers that the originator/co-originator must select from the selected approver group may be defined in the signature mandates obtained at step 402. If no approver groups have been predefined in tool 18, the originator/co-originator can add approvers by entering the e-mail addresses or selecting them from a drop-down list, as illustrated in screenshot 440b shown in FIG. 34.

As discussed above, in some cases, the proposed activity requires the approval of the compliance organization (due to the value of the proposed activity or if any compliance risk danger sign question was answered “yes”). In such cases, after selecting the approver(s) at step 404, one or more compliance officers defined for the relevant business entity are automatically displayed to the originator/co-originator, e.g., as shown in the example screenshot 450 of FIG. 35 (step 406). If the proposed activity is not subject to approval by the compliance organization, this section is not displayed. Further, if the value of the activity exceeds a predefined threshold value for that activity type, responsible persons from the corporate communications group are also automatically added as approvers, as shown in FIG. 35 (step 408). If the proposed activity is not subject to approval by the corporate communications group, this section is not displayed.

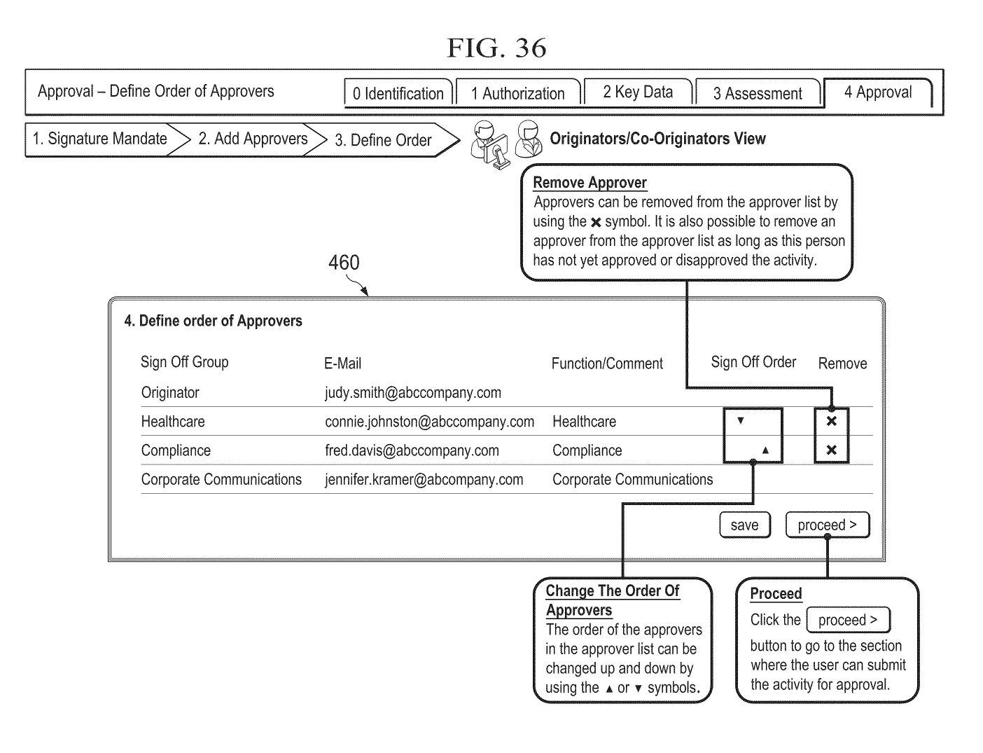

After all approvers have been selected or determined at steps 404-408, the approvers are displayed to the originator/co-originator in an approval list, e.g., as shown in the example screenshot 460 of FIG. 36 (step 410). The order of the list defines the order of the approval decision, starting with the approver at the top of the list and progressing down the list in order. The approvers are automatically listed in the order of their selection. The compliance officer or administrator can predefine the approval sequence in the administration section and can determine whether this sequence can be changed by the originator/co-originator Approval module 28 allows the originator/co-originator to change the sequence of the listed approvers (if maintained by the compliance officer or administrator), except for any corporate communications persons, which remain at the end of the list.

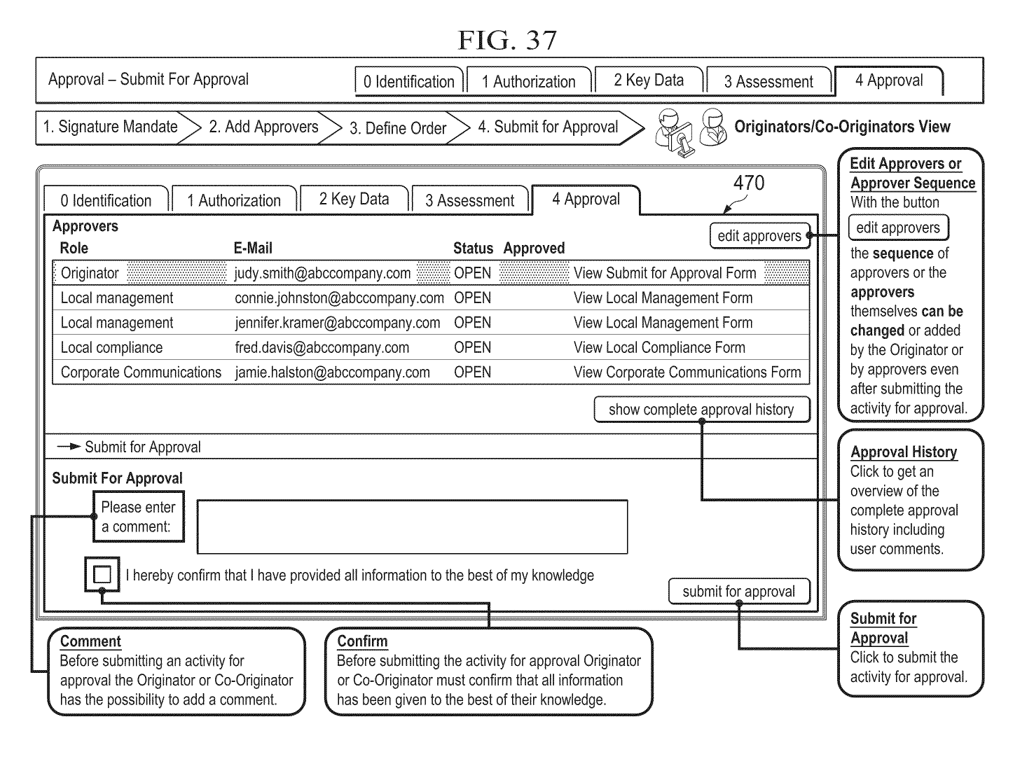

Before submitting the activity for approval, the originator/co-originator must confirm that all entered information was given to the best of the originator's/co-originator's knowledge. FIG. 37 illustrates an example screenshot 470 presented to originator/co-originator for confirming that all entered information was given to the best of the originator's/co-originator's knowledge, and to add a comment if desired. The originator/co-originator may then submit the activity for approval by clicking a “submit for approval” button (step 412).

By submitting the activity for approval, approval module 28 automatically changes the status of the activity from “in assessment” to “in approval” and sends the first approver an e-mail notification with a request for approval. After the first approver approves the activity, approval module 28 automatically sends the second approver an e-mail notification with the same request for approval, and so on down the list of approvers.

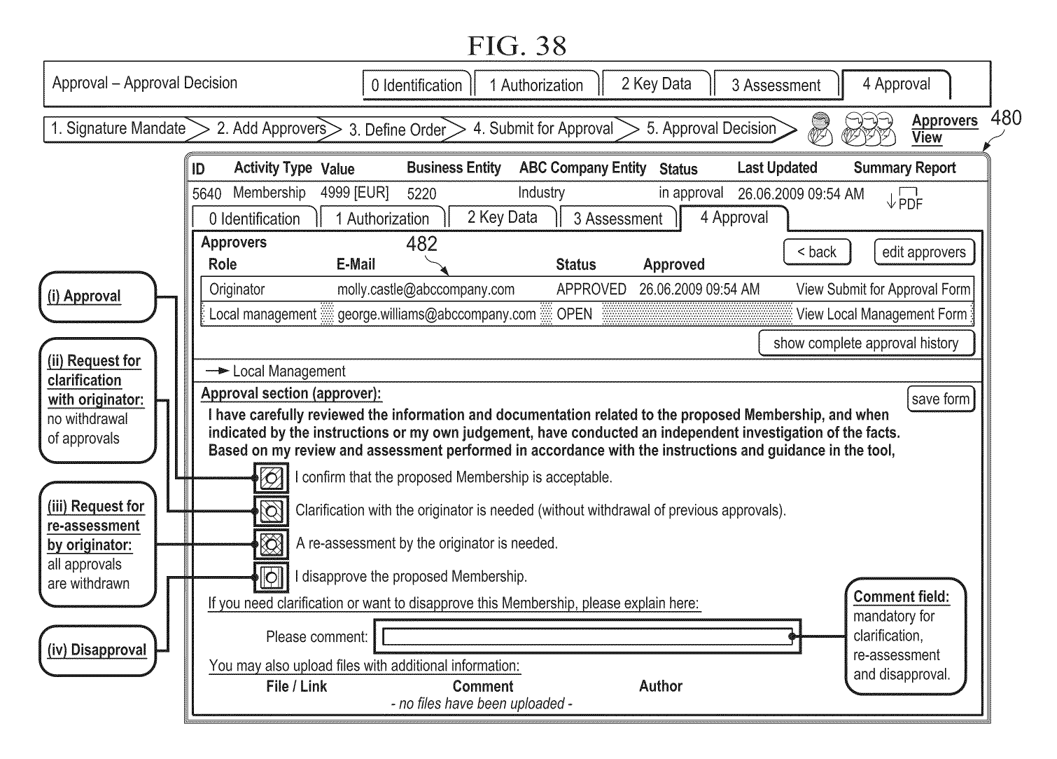

When an approver receives the e-mail notification with the request for approval, the approver may log into tool 18 in order to make the approval decision (step 414). FIG. 38 illustrates an example screenshot 480 presented to the approver for making the approval decision. The approver may review information related to the proposed activity either through screens displayed by approval module 28 or by downloading/printing a PDF summary report for the proposed activity.

As shown in FIG. 38, screen 480 indicates the approval decisions 482 of each previous approver, and provides an approval decision and/or comment area 484. In this example embodiment, the approver may (a) approve the activity, (b) request clarification from the originator, (c) require a re-assessment of the activity by the originator, or (d) disapprove the activity.

If the approver approves the activity, the activity is approved and forwarded to the next approver.

If the approver sees the need for a clarification, the approver he may submit the activity for clarification with the originator. The approver must provide a comment in the comment field describing the details of the clarification request. The clarification request does not affect any previous approvals by other approvers.

If the approver decides that substantial changes need to be made which require a repetition of the whole approval process, the approver may require a re-assessment. The approver must provide a comment in the comment field describing the reason for the re-assessment. Any existing approvals are withdrawn, and the approval process is fully restarted.

The activity is approved only after all approvers approve the activity. The activity is stopped if any of the approvers disapproves the activity. As shown in FIG. 38, approval module 28 may allow the approver to edit the approval order and/or the identify of the approvers.

If, during the assessment phase, the originator/co-originator answered “yes” to any compliance risk danger sign question, the compliance officer specified for the relevant business entity (or any assigned deputy compliance officer) must check and comment on the originator's/co-originator's “yes” answer. This comment becomes visible for other approvers.

In certain instances, the originator may make changes to the submitted activity after approval by one or more approvers. Specifically, uncritical data may be changed by originator when required, whereas read-only or critical data can only be changed after re-opening the activity from the approval section.

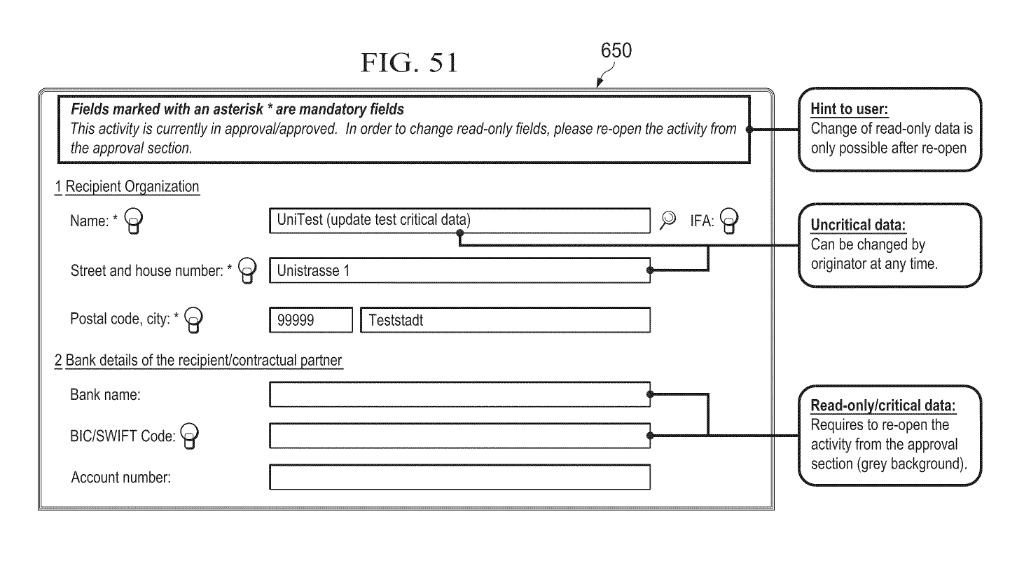

FIG. 51 illustrates an example screenshot 650 indicating examples of uncritical data that can be changed at any time by the originator, and read-only/critical data that can only be changed after re-opening the activity from the approval section. The read-only/critical data fields may be indicated as grayed-out or otherwise visually distinguished from the uncritical data.

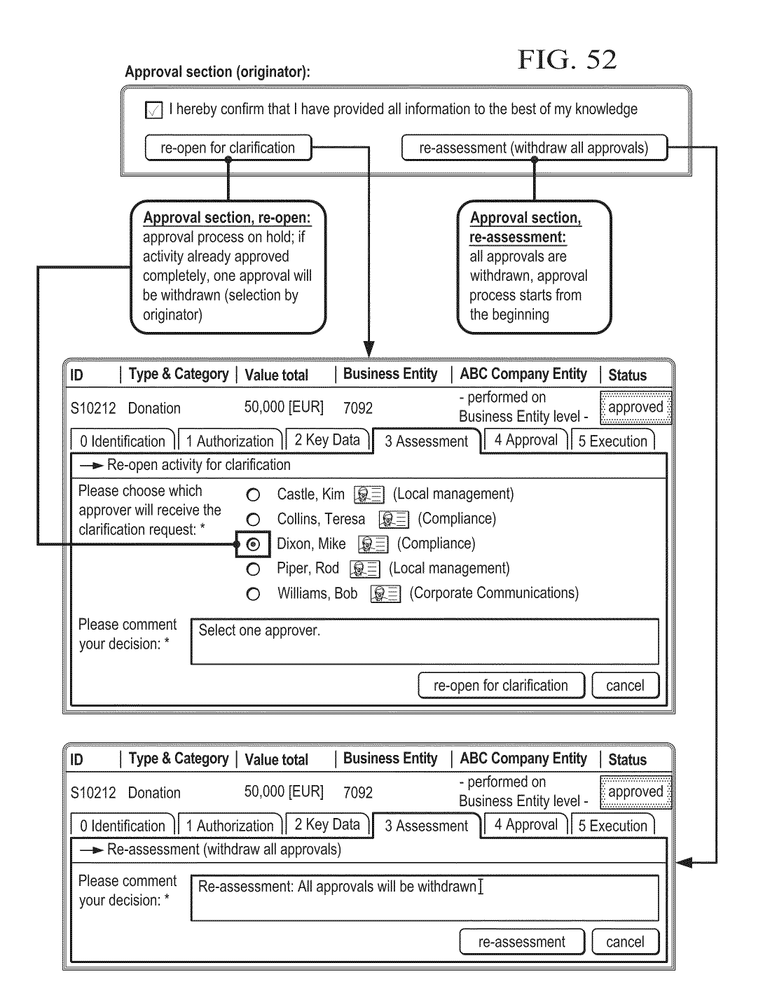

FIG. 52 illustrates the difference between (a) the originator re-opening an approval process, e.g., to change read-only or critical data, and (b) the originator initiating a re-assessment of the approval process. If the originator re-opens the approval process (e.g., to change read-only or critical data), the approval process is placed on hold. If the activity has already been approved completely (i.e., by all approvers), the approval of one approver, selected by the originator, is withdrawn. In contrast, if the originator initiates a re-assessment of the approval process, all approvals are withdrawn and the approval process restarts from the beginning.

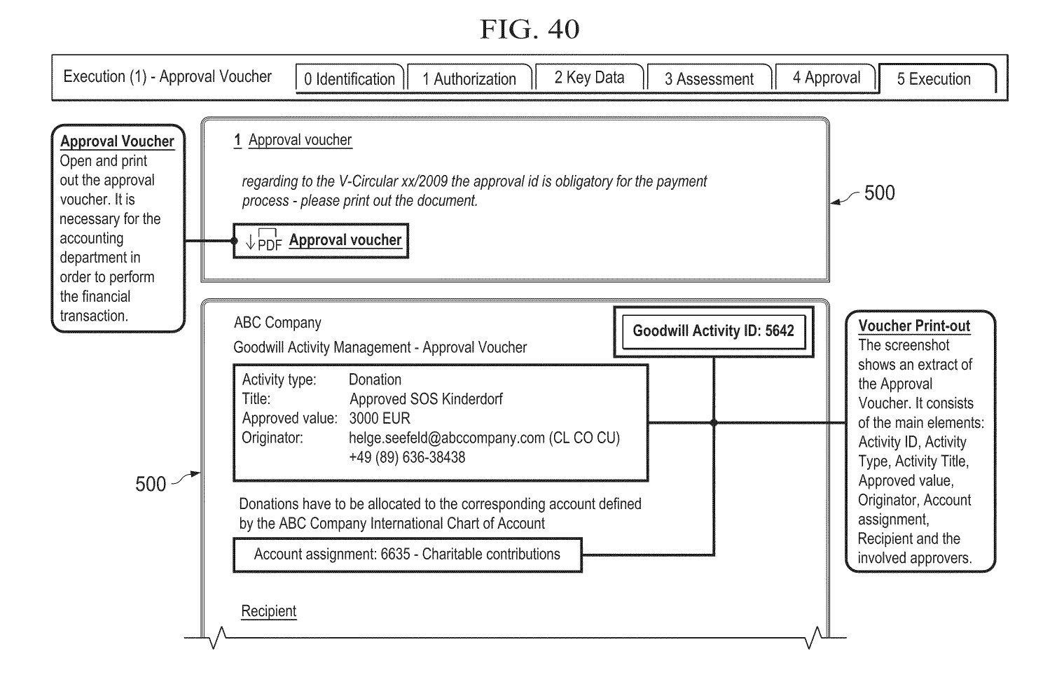

After the activity has been approved by all approvers, the execution phase is activated. In the execution phase, execution module 30 allows the originator/co-originator to upload and document information regarding the execution and measurement of the activity. For sponsoring and hospitality packages, the completion of eth execution phase is mandatory. However, also for other contributions without consideration, the completion of the execution phase (e.g., upload of donation receipts) may be necessary or mandatory depending on local regulations. In addition, an approval voucher for the activity is generated in order to ensure that contributions are booked to correct accounts with a reference to the activity ID number for the activity. FIG. 40 illustrates an example screenshot 500 showing an example approval voucher, which may be opened/printed as shown.

The next part of the execution phase depends on the activity type. In general, the following parts must be processed:

(a) The current status of the activity;

(b) Execution documentation: to be filled out after the contract has been signed and/or the payment has been performed. For donations, the donation receipt or another type of confirmation by the recipient organization must be uploaded. For sponsoring and hospitality packages, the copy of the original contract must be uploaded.

(c) Activation and measurement documentation: to be filled out after the activity has been conducted. For donations, the evaluation activities (was the donation used for the agreed purpose? was it used effectively?) can be documented. For sponsoring and hospitality packages, the documentation of the successful activation and/or the measurement documentation specified by local requirements must be uploaded.

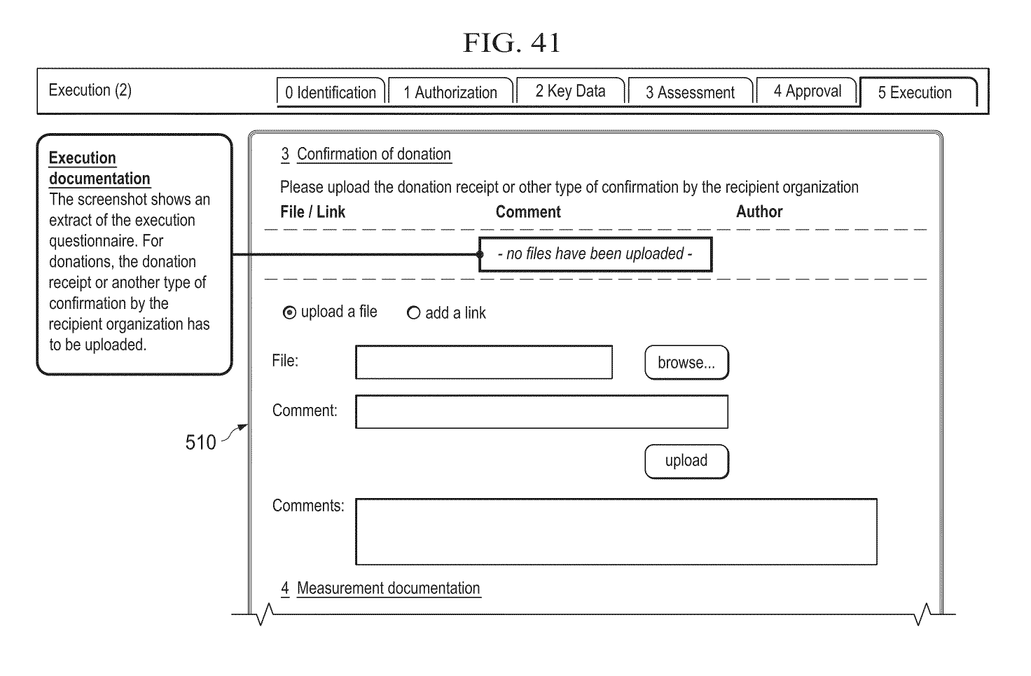

FIG. 41 illustrates an example screenshot 510 showing an interface for uploading execution documentation and/or providing comments regarding the execution of the activity.

### Administrative Functions Provided by Goodwill Activity Management Tool 18

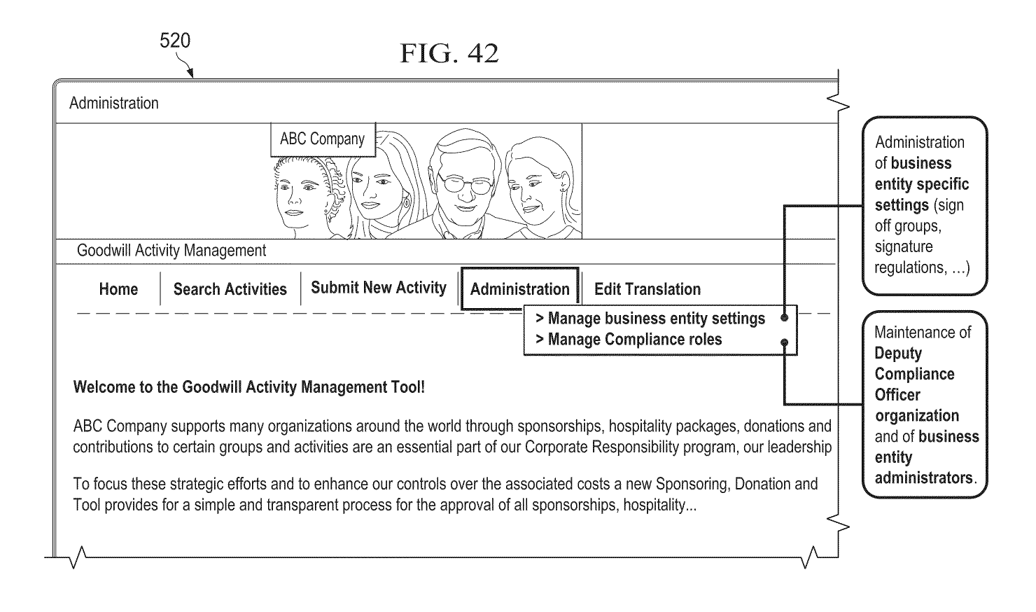

Tool 18 allows authorized administrators to perform various administrative functions related to the performance of tool 18, such as managing business entity settings and managing compliance roles. FIG. 42-50 illustrate example screenshots of certain administrative functions facilitated by tool 18, according to certain embodiments. Such functionality may be provided by administrative module 32.

FIG. 42 illustrates an example screenshot 520 showing the welcome (or “home”) screen, including selectable administration options: “manage business entity settings” and “manage compliance roles.”

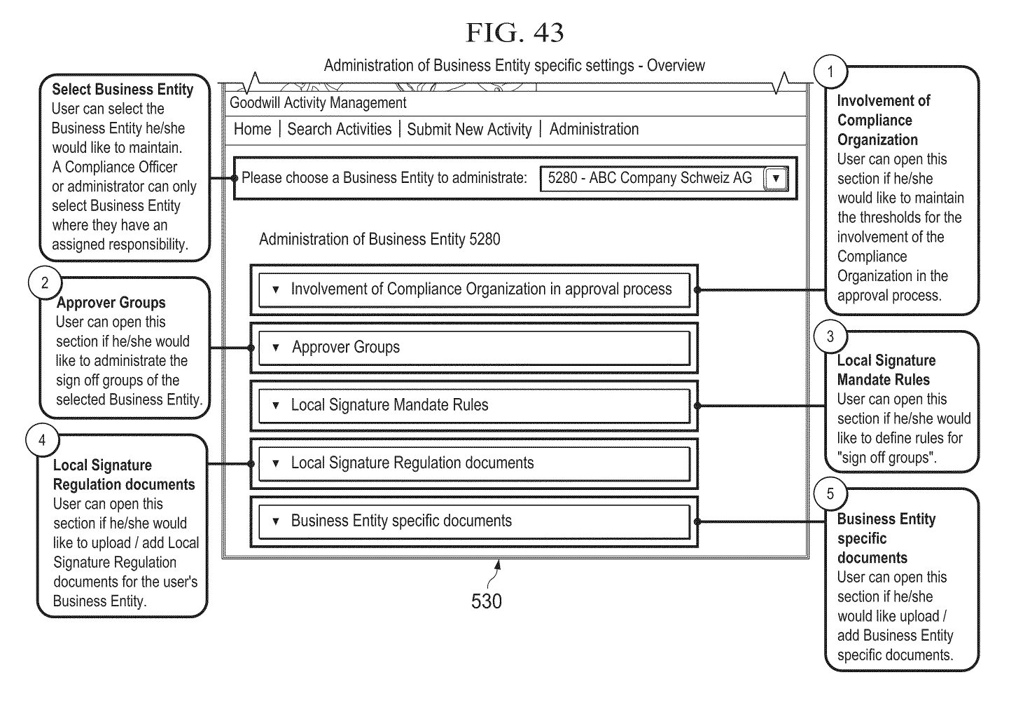

FIG. 43 illustrates an example screenshot 530 showing the various selectable administrative functions displayed upon selection of the “manage business entity settings” option in FIG. 42. As shown in FIG. 43, the selectable administrative functions include:

(1) Involvement of Compliance Organization—allows the administrator to manage thresholds used by tool 18 for making various decisions (e.g., activity value thresholds for triggering involvement of a compliance officer).

(2) Approver Groups—allows the administrator to specify approvers or an approver group for a particular business entity.

(3) Local Signature Mandate Rules—allows the administrator to define rules for approvers/approver groups for making activities approval decisions.

(4) Local Signature Regulation documents—allows the administrator to upload or add signature (i.e., approval) regulation documents for the relevant business entity.

(5) Business Entity specific documents—allows the administrator to upload or add other documents specific to a particular business entity.

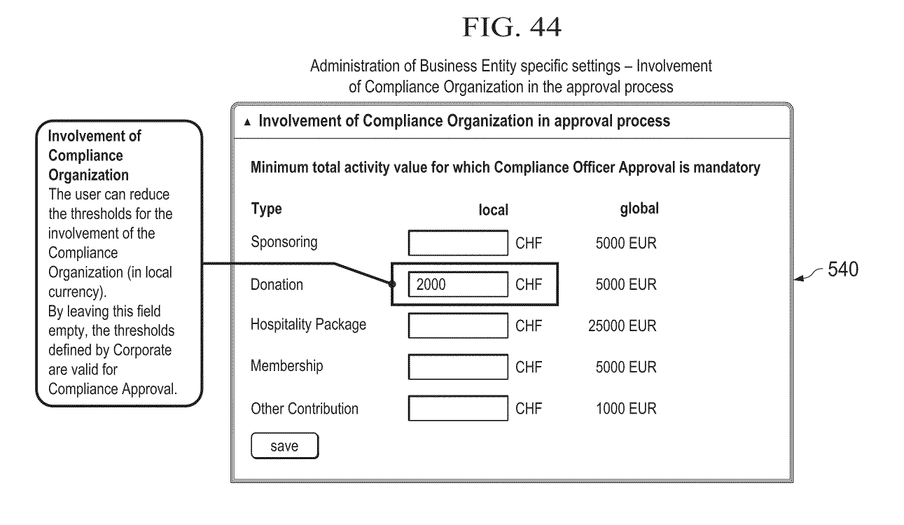

FIG. 44 illustrates an example screenshot 540 displayed upon selection of the “Involvement of Compliance Organization” option in FIG. 43. As shown, administrative module 32 allow the administrator to reduce (but not increase) the activity value thresholds used for triggering the involvement of the compliance organization, for each activity type and business entity.

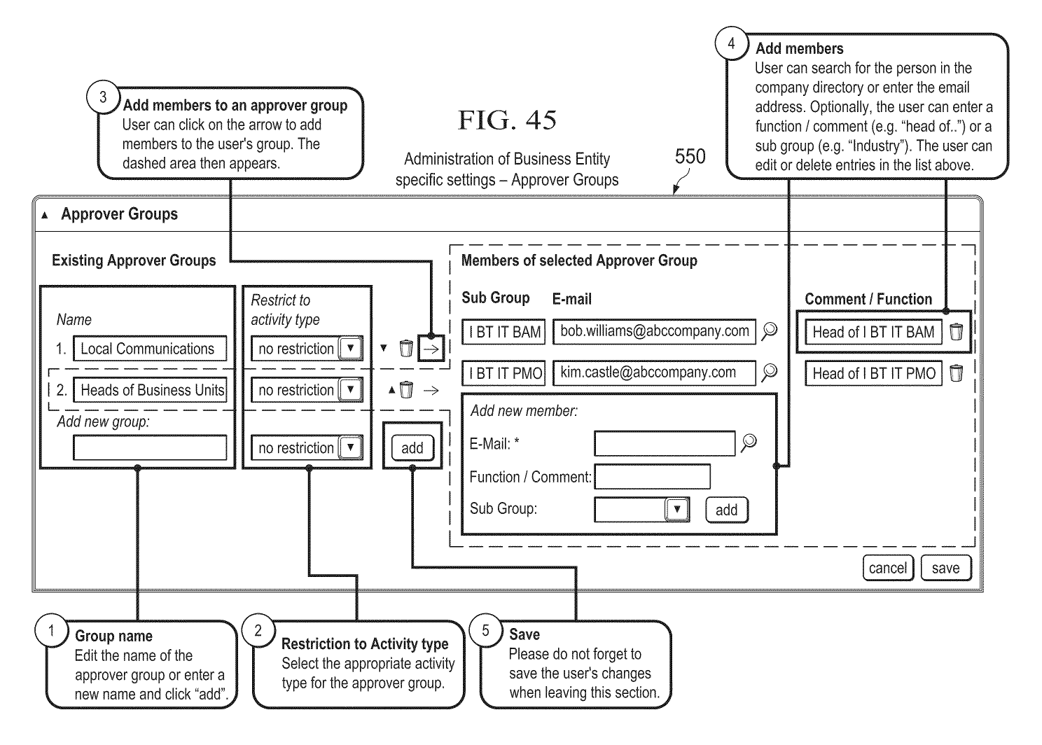

FIG. 45 illustrates an example screenshot 550 displayed upon selection of the “Approver Groups” option in FIG. 43. Administrative module 32 allows compliance officers and administrators to define one or more approver groups for an activity and to add persons to those groups, in order to allow originators/co-originators to select approvers from these groups.

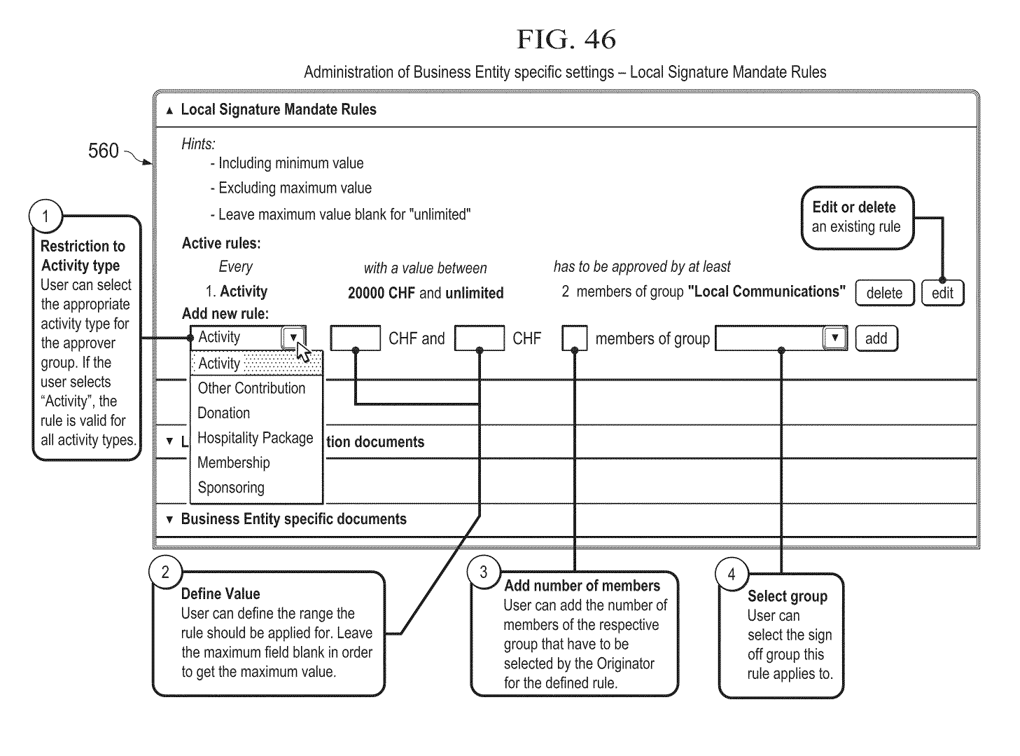

FIG. 46 illustrates an example screenshot 560 displayed upon selection of the “Local Signature Mandate Rules” option in FIG. 43. Administrative module 32 allows administrators to define value levels for each approval group in order to ensure that value based signature regulations for a business entity are adhered to. The minimum number of persons that have to be selected from each approver group can also be defined. For example, as shown in FIG. 46, an administrator may define that each activity with a value of at least 20,000 Euros must be approved by at least two members of the approver group named “local communications.”

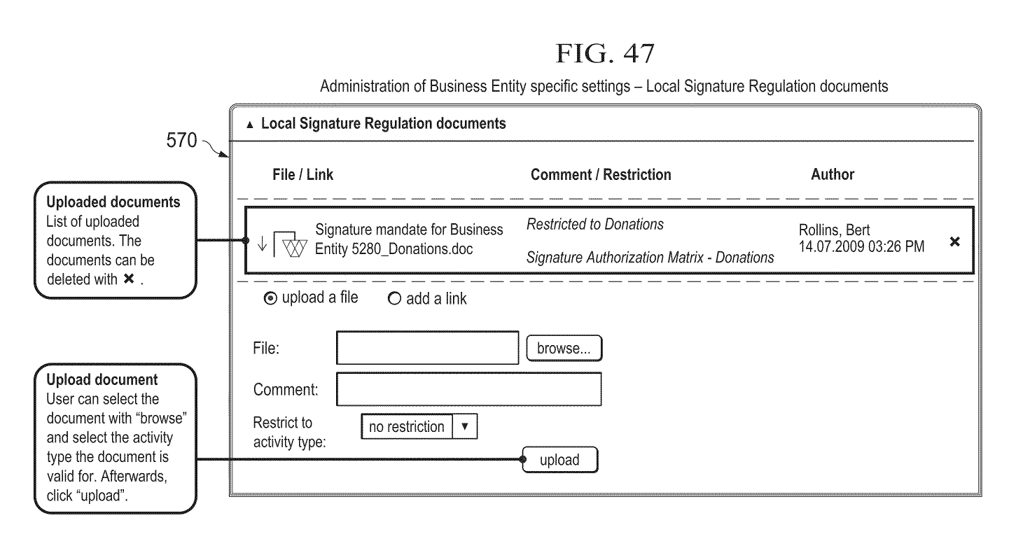

FIG. 47 illustrates an example screenshot 570 displayed upon selection of the “Local Signature Regulation documents” option in FIG. 43. Administrative module 32 allows an administrator to upload or add a link to signature regulations for each business entity and activity type.

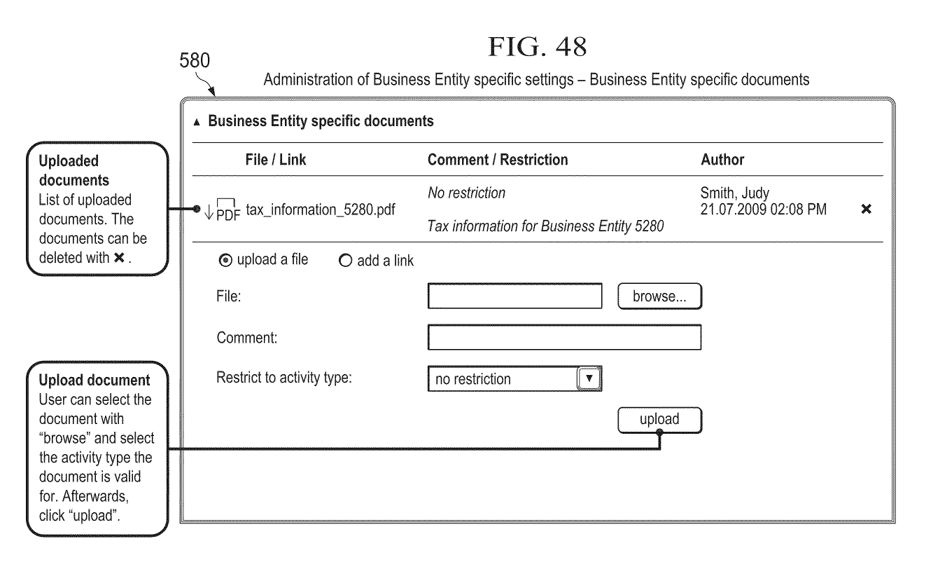

FIG. 48 illustrates an example screenshot 580 displayed upon selection of the “Business Entity specific documents” option in FIG. 43. Administrative module 32 allows an administrator to upload or add a link to other business entity specific documents or data.

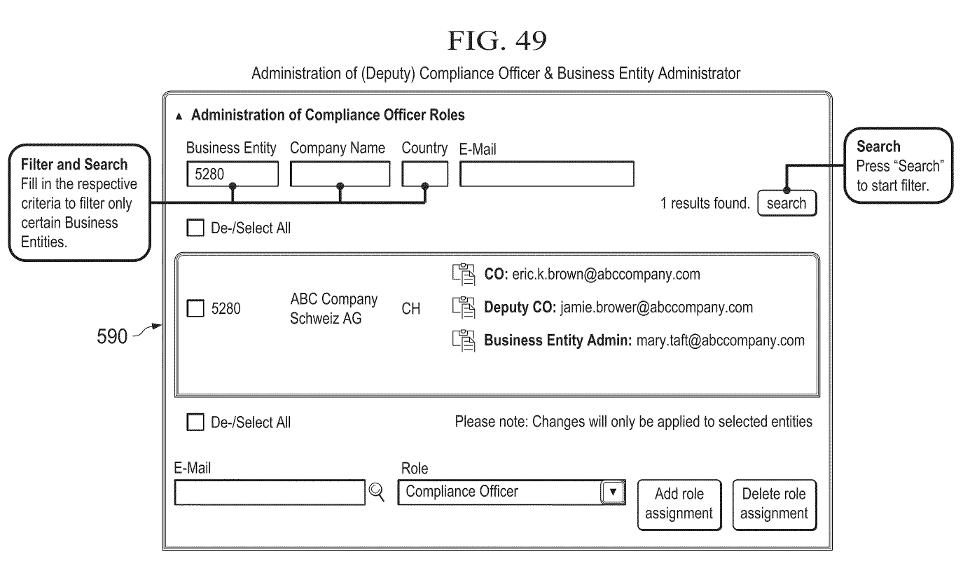

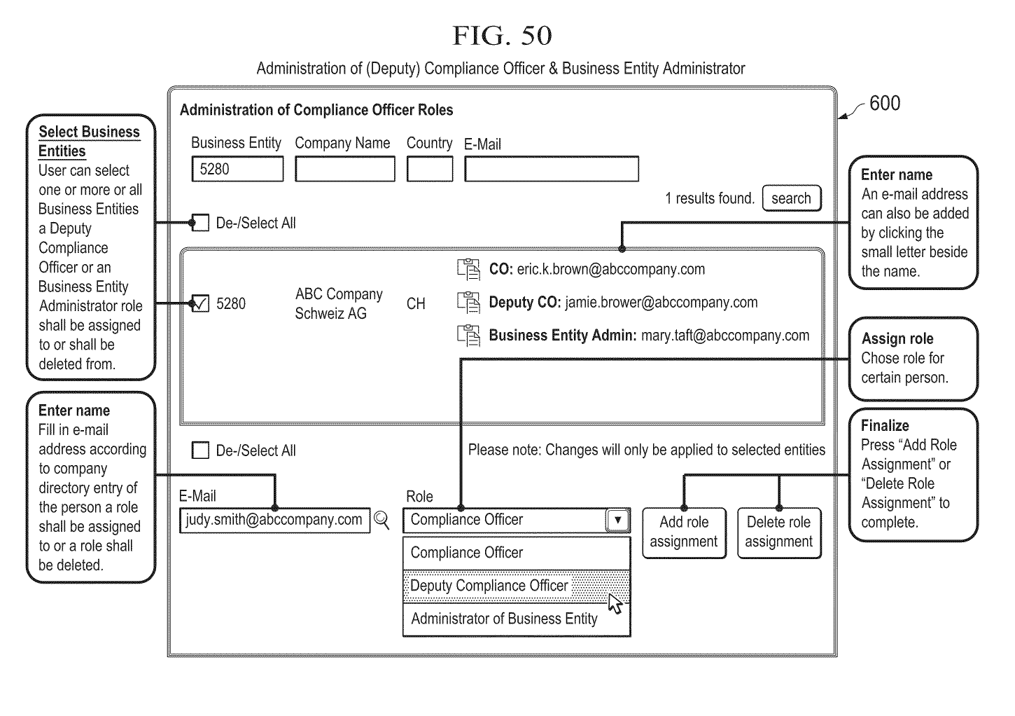

FIGS. 49 and 50 illustrate example screenshots 590 and 600 showing the various selectable administrative functions displayed upon selection of the “manage compliance roles” option in FIG. 42. Administrative module 32 allows an administrator to manage roles (i.e., select or change designated persons) for compliance officers, deputy compliance officer roles, and business entity administrators.

### Invitation Type Activities and Invitation Approval Tool 38

As discussed above, “invitation” type activities, such as invitations of third party guests to events for entertainment purposes and/or payment of costs for non-local travel and lodging (accommodation) for such guests, may be handled by invitation approval tool 38. The process flow for handling invitation type activities by invitation approval tool 38 is discussed below.

FIG. 53 illustrates an example process flow 700 for the identification, authorization, evaluation, approval, and execution of an invitation type activity using tool 38, according to certain embodiments. In this example, the process includes the following phases: an activity identification phase (1), an authorization phase (2), an invitation data collection phase (3), a participants data phase (4), and an approval phase (5). An execution phase (6) becomes visible after the approval of the activity and provides an approval voucher. The first four phases (1)-(4) are performed by the department within the business entity of ABC Company that proposes the activity. The approval phase (5) is conducted by authorized persons according to local (e.g., business entity specific) signature regulation and, if applicable, by the compliance organization who is responsible for that business entity.

In the activity identification phase (1), the activity type is identified through interaction between the activity originator and identification module 20 (or similar module of tool 38). The identification of the “invitation” activity type may be facilitated using one or more identification checklists 34. In addition, certain pre-selection criteria defined for the “invitation” activity type may need to be confirmed, e.g., similar to the criteria discussed above regarding FIG. 18. In some embodiments, tool 38 may require the originator (e.g., via one or more questions) to select between a “high risk” and a “los risk” invitation activity. “High risk” and “low risk” invitation activities may be defined by a gifts and hospitality policy of ABC Company. For example, “high risk” invitation activities may include activities invitations of third party guests to entertainment events and/or payment of costs for non-local travel and lodging (accommodation) for such guests, whereas “low risk” invitation activities may include small gifts and invitations to meals. Upon selection of a “high risk” invitation activity, tool 38 may route the originator through the process flow 700. In contrast, upon selection of a “low risk” invitation activity, tool 38 may route the originator to a “provision scorecard” (included by, or outside of, tool 18), which the user must complete in order to determine whether the “low risk” activity requires approval by an appropriate compliance organization.

The authorization phase (2) may be facilitated by authorization module 22 (or similar module of tool 38) and may be similar to the authorization phase discussed above with respect to FIG. 19. For example, during the authorization phase (2), the originator may assign viewer rights and/or editor rights to other persons. By finalizing this phase, the activity is recorded in the database.

In the invitation data phase (3), general information regarding the invitation, as well as details of the budget, agenda, etc. are entered by the originator. If the originator does not yet know the names of the participants, the originator can apply for a pre-approval of the activity. For a pre-approval, the process skips the participants data phase (4) and proceeds directly to the approval phase (5), as indicated in FIG. 53. In this case, the originator can enter the names of participants after the approval (and/or activity date) of the event.

If the activity is not pre-approved, the process moves to the participants data phase (4), in which the originator can enter the names of participants, if their names are known at that point (if not, the names may be entered for some period after the activity date, e.g., up to 30 days after the activity date).

In the approval phase (5), a separate approval is performed for (a) the participants and (b) the event itself. In some embodiments, compliance approval is always required. Other persons (e.g., local management) can be included in the approval of the event, if required and maintained by the respective entity of ABC Company. The separation of the event approval from the participant approval allows for independent decision of participants even after the event has occurred.

Finally, for the execution phase (6), the execution display becomes visible after the approval of the event. Here, execution module 30 (or similar module of tool 38) facilitates the uploading and/or documenting of information concerning the execution and measurement of the activity. In addition, the approval voucher for the accounting department is generated.

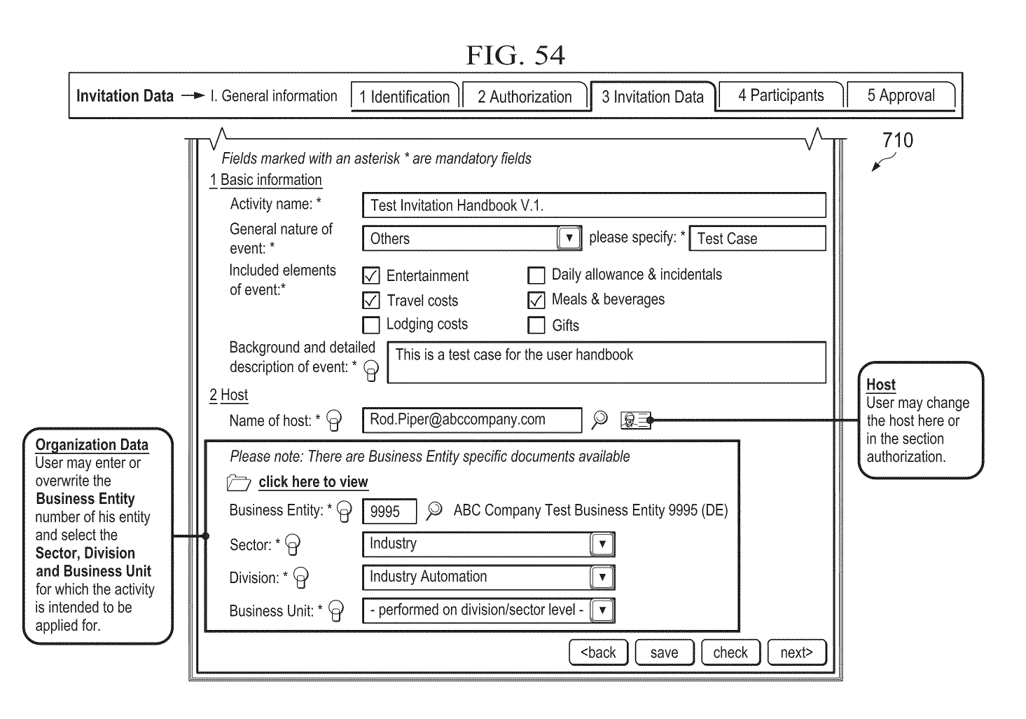

More details of process flow 700 are discussed below, with example screenshots (FIGS. 54-61) provided for aspects of process flow 700 that differ from process flow 100 discussed above regarding FIGS. 7-50.

As discussed above regarding FIG. 16, a user may select an invitation type activity during the activity identification phase (1) provided by tool 18, which may forward to process to tool 38. The authorization phase (2) may be similar to the authorization phase discussed above with respect to FIG. 19.

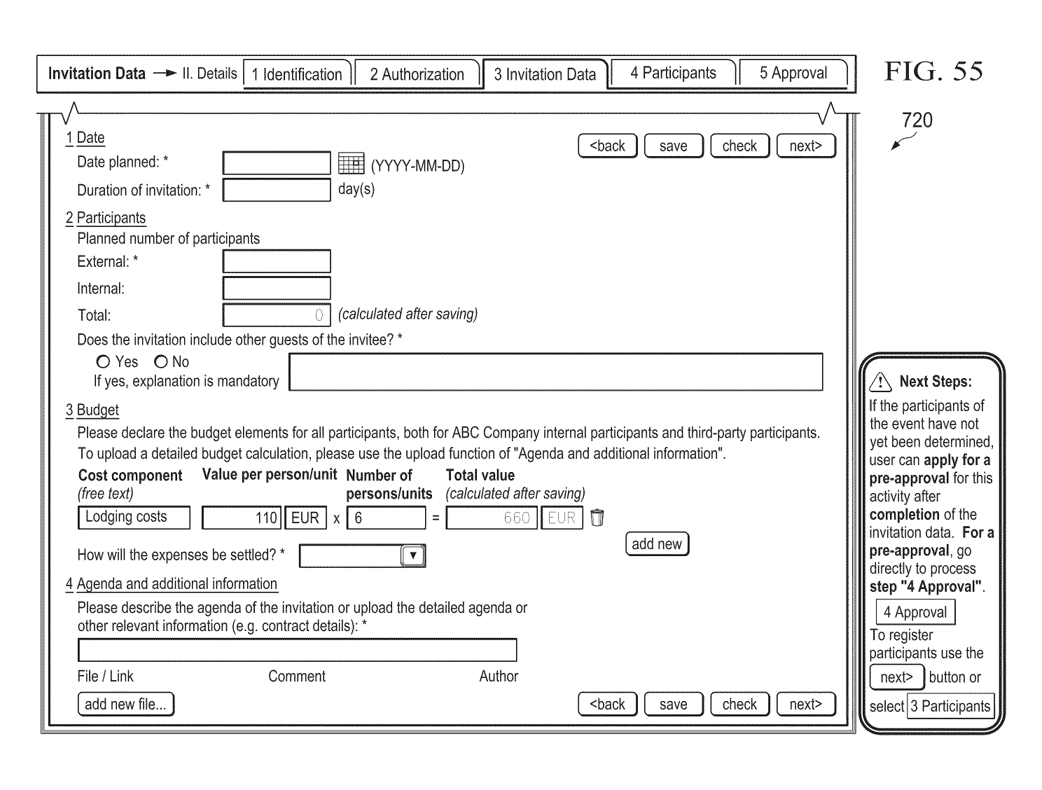

As discussed above, in the invitation data phase (3), general information regarding the invitation, as well as details of the budget, agenda, etc. are entered by the originator. FIGS. 54 and 55 illustrate example screenshots 710 and 720 for entering general information, and more specific details, respectively, regarding the invitation activity.

After the invitation data phase (3), the process moves to the participants data phase (4), unless the originator applied for a pre-approval, in which case the process skips to the approval phase (5). Some details of the participants data phase (some of which have been discussed above) include:
Approval of event and participants: The event itself and the participants must be approved independently. If the participants of the event are already determined, the originator registers the participants in the participants data phase (4), and submits the vent and the participants for approval.
Pre-approval: If the participants of the event have not yet been determined, the originator can skip the participants data phase (4), and submit the event directly for approval without registration of participants. This is referred to as applying for pre-approval of the event.
Involvement in the approval of event and decision on participants: The approval of the event and the decision on the participants must be performed by one compliance officer of the relevant ABC Company entity. However, entities can define that the additional approvers (e.g., local management) are also involved in the approval of the event. In this case, the local management is responsible for the approval of the event and the relevant compliance organization is responsible fort he approval of the vent AND the decision on participants. The approval rules are automatically pre-determined for the approval phase (5).
Changes of participants: Within 30 days (or other predefined period) after the end date of the event, the originator may register new participants, edit existing entries, and inform the relevant compliance organization about such changes. However, after days (or other predefined period) after the end date of the event, participants can no longer be registered and/or approved.
Participation: Registered persons may be automatically marked as participating in the event. Registered persons who did not participate in the event much be marked as non-participating in the participants data phase (4) within 30 days (or other predefined period) of the event date.

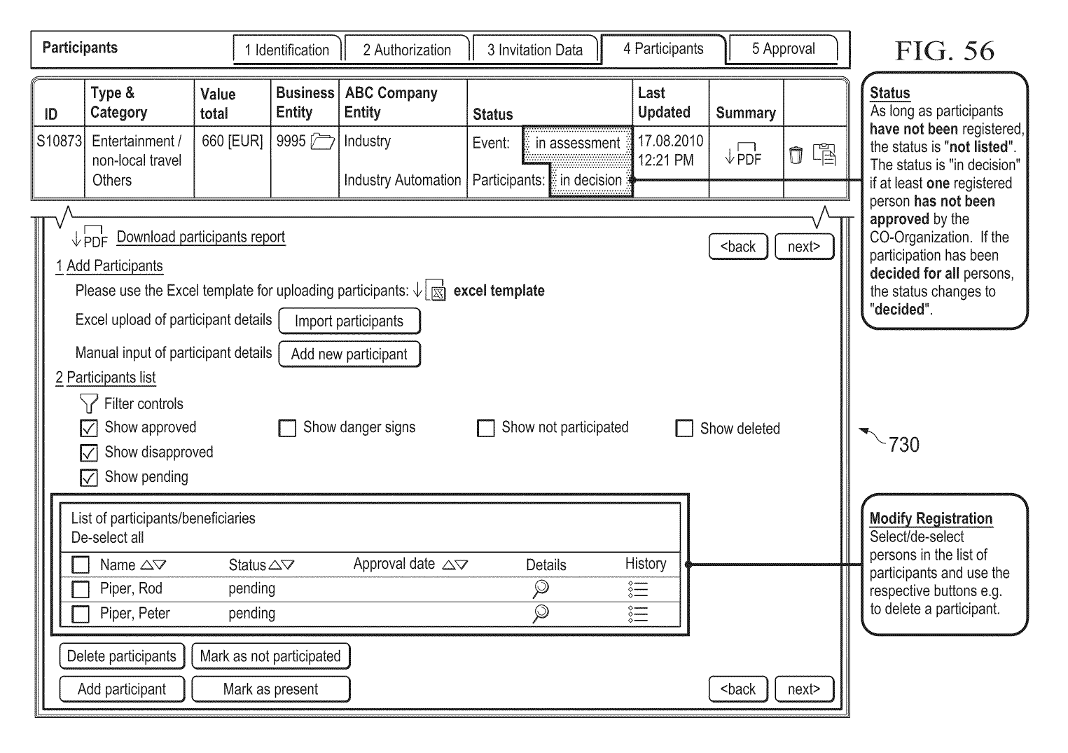

FIG. 56 illustrates an example screenshot 730 from the participants data phase. Screenshot 730 provides the originator an interface to add participants, modify registration of an event, view the status of the participant entry/approval process, and control the displayed list of participants (e.g., by setting filters). Participants may be added either manually or by uploading a spreadsheet or other file. To manually enter a participant, the originator may click the “Add new participant” button shown in screenshot 730, which opens a participant form to be filled out by the originator, and saved. To enter participants by spreadsheet, the originator may (a) click the “excel template” button shown in screenshot 730, which opens a predefined MICROSOFT EXCEL form, (b) enter the relevant participant details in the form and save the file, and (c) click the “Import participants” button shown in screenshot 730 and select the saved file to import.

After the participants data phase (4), the process moves to the approval phase (5). The approval phase for invitation activities is generally similar to the approval phase discussed above regarding FIGS. 32-37.

As a default rule, the approval of the invitation activity (a) event and (b) participants must be performed by one compliance officer of the relevant ABC Company entity. However, an ABC Company entity can define and maintain in the tool that additional approvers (e.g., local management) are also involved in the approval of an event.

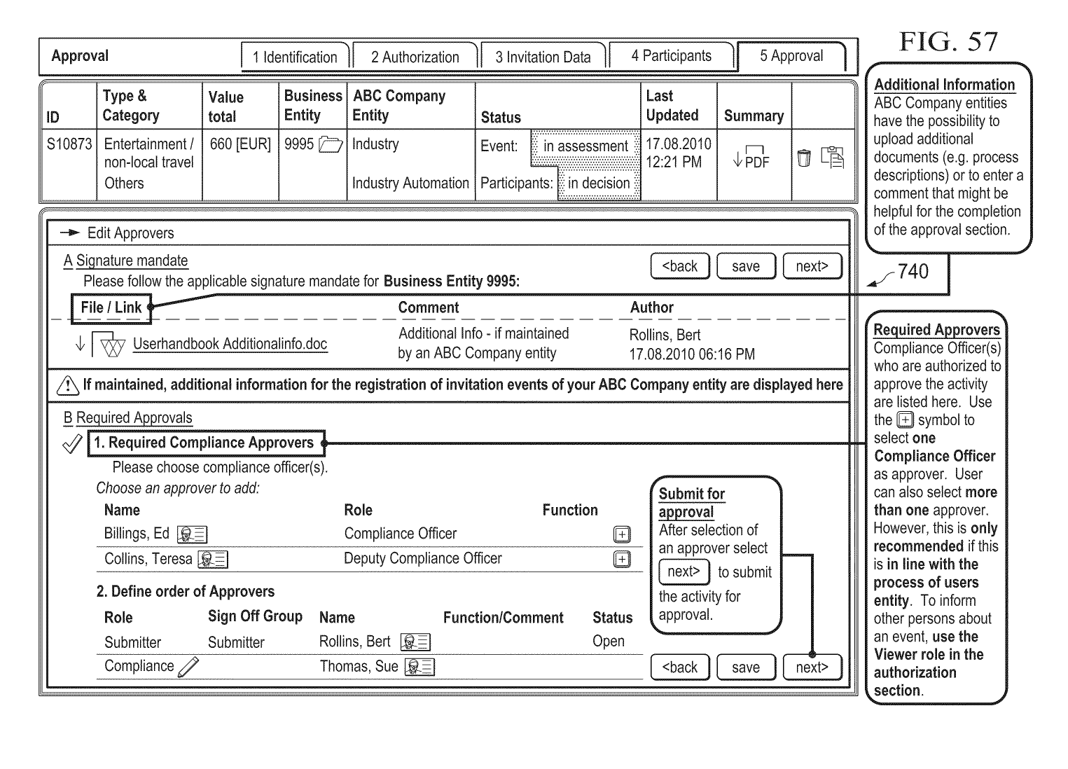

FIG. 57 illustrates an example screenshot 740 from the approval phase. The originator may select one compliance officer as the approver (or multiple approvers as defined by the ABC Company entity, as discussed above). The originator may then submit the activity for approval.

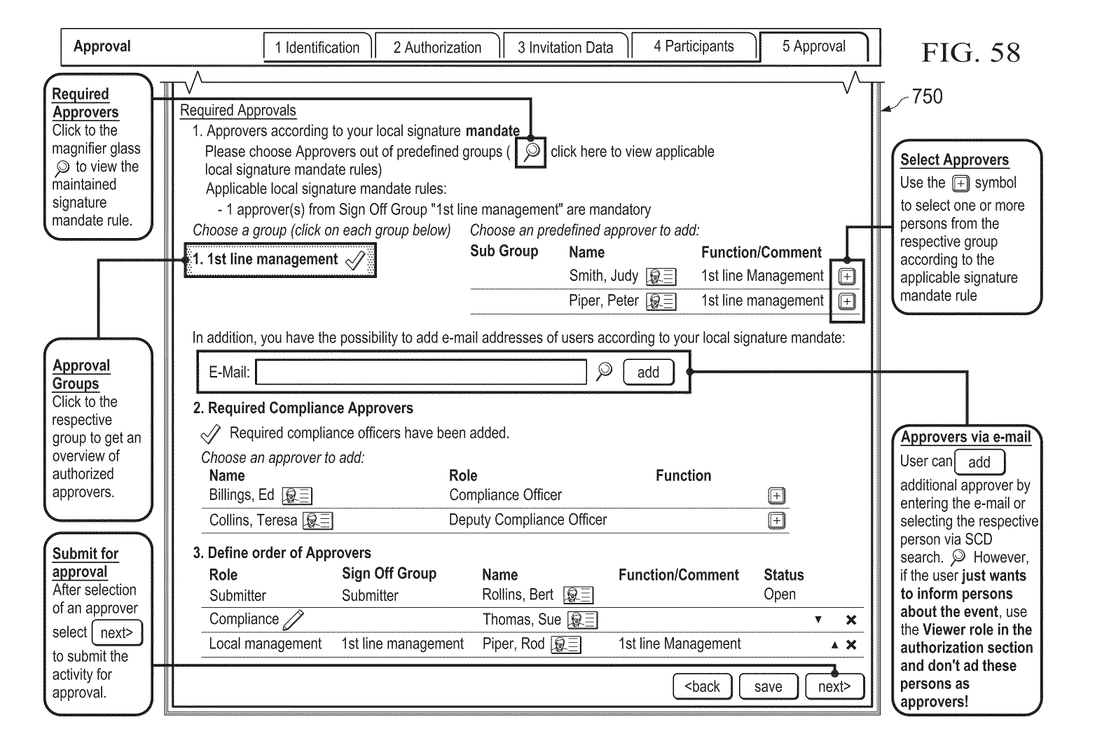

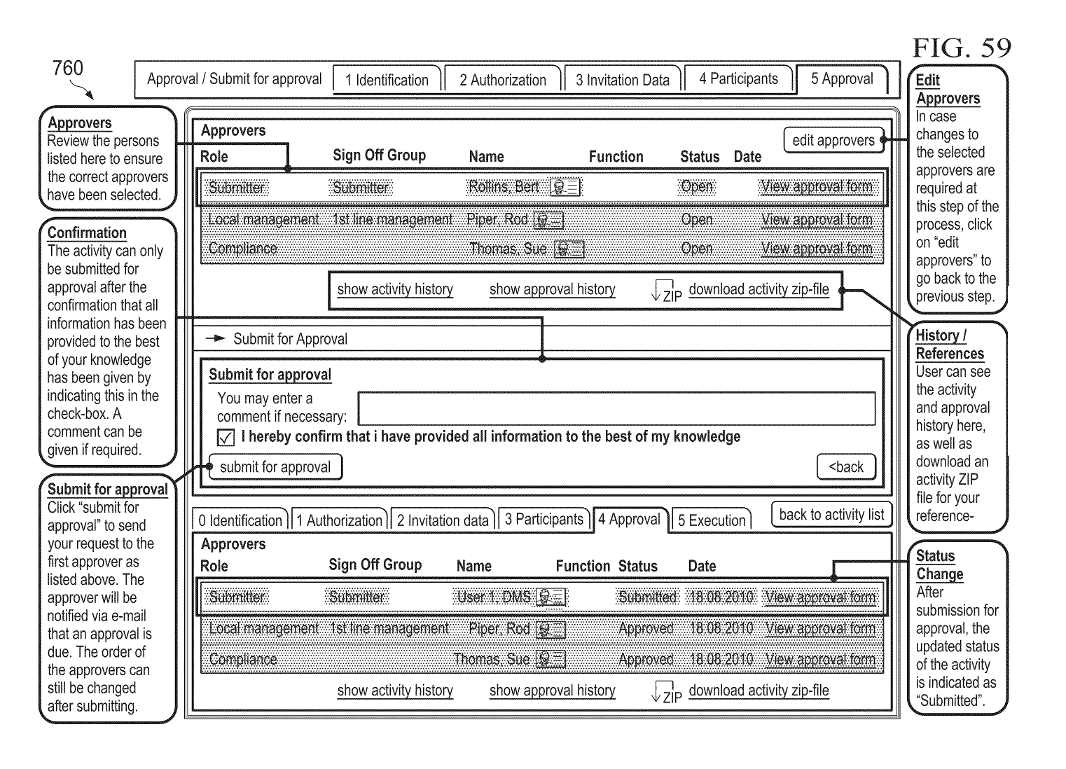

Tool 18 and/or tool 38 may allow each ABC Company entity to define and maintain signature regulation rules for each activity type. If maintained, not only compliance officers but additional persons are involved in the approval of an invitation activity. The value of the invitation (total or per person) may affect the applicable signature regulation rule. FIG. 58 illustrates an example screenshot 750 for selecting approvers or approver groups. Such interface may also include similar features as shown in FIGS. 33 and 34, discussed above. FIG. 59 illustrates an example screenshot 760 of the final step before submitting for approval. As shown, the tool displays the names of all approvers. A confirmation that all information has been provided to the best of the originator's knowledge may be required before the activity can be submitted for approval.

After approval of the activity, the execution phase (6) is entered and the execution display becomes visible. In addition, an approval voucher may be generated. The execution phase is similar to the execution phase discussed above regarding FIGS. 40-41.

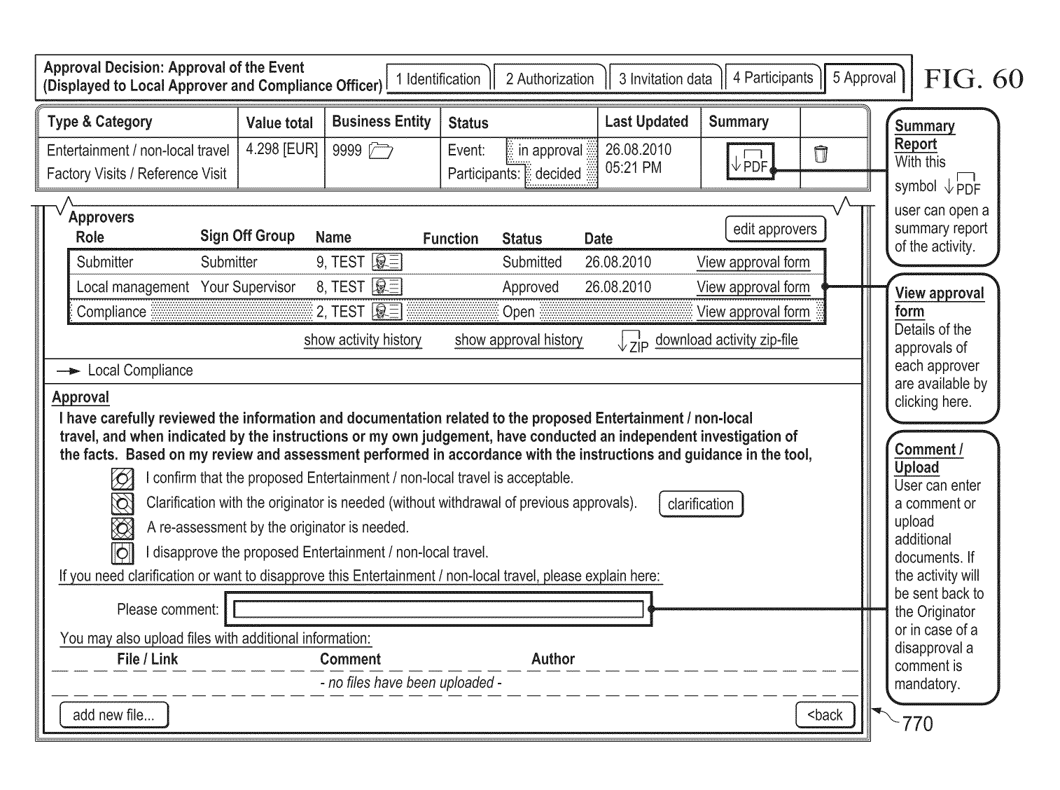

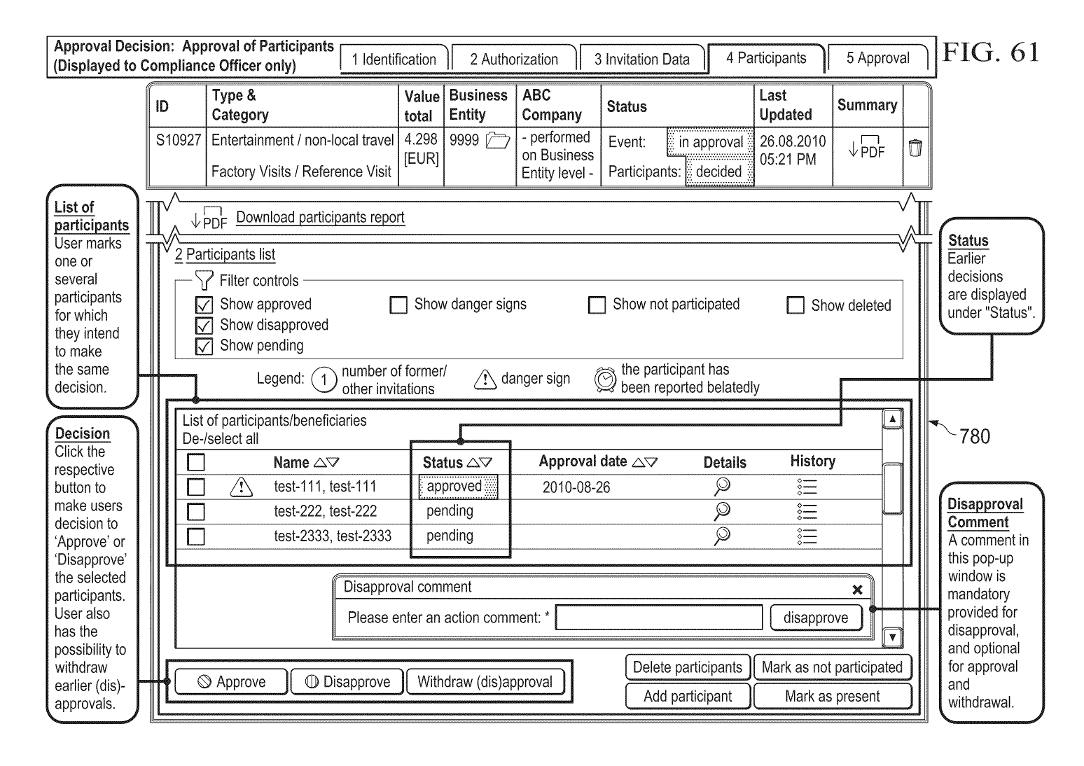

As discussed above, the approval of invitation activity (a) events and (b) participants must be performed by one compliance officer of the relevant ABC Company entity. Local signature regulations may assign the local management or other authorized persons as additional local approvers. These additional approvers are only required to approve the event—i.e., they do not make a decision regarding the participants. In view of these rules: FIG. 60 illustrates an example screenshot 770 for the approval of the invitation activity event, which screen is displayed to the compliance officer and also to each local approver (if defined by local signature regulations); and FIG. 61 illustrates an example screenshot 780 for the approval of the invitation activity participants, which screen is displayed only to the compliance officer (and not to the local approvers, if any).

Regarding the approval of the invitation activity event, shown in FIG. 60, when an invitation activity is submitted for approval, the first approver receives an e-mail notification with a request for approval. After the approval of the first approver, the second approver receives an a-mail notification with the same request, and so on. One of the approvers is the compliance officer. Approvers are able to check the activity either in the respective screens or by using a PDF report generated for the activity.

Regarding the approval of the invitation activity participants, shown in FIG. 61, when the compliance officer receives the e-mail notification with the request for the approval of the event, the compliance officer can also decide regarding the participants. The compliance officer must make a decision for each participant individually. As the originator can add participants up to 30 days (or other defined time period) after the event, the compliance officer is notified by subsequent e-mails in order to make decisions regarding each of such later-added participants.

### Language Translation

As discussed above, translation tool 39 of goodwill activity management tool 18 provides multiple language translations of text displayed by tool 18, and allows defined “translators” to edit the respective translations. In some embodiments, due to the fact that the length of translated sentences affect the layout of the system display, there are two types of translations applicable and visible for users:
1. For certain screens (e.g., the welcome, identification checklist, pre-selection criteria, authorization, compliance assessment, approval, and execution sections), a direct translation is available. Translations will be directly visible in the screenshots displayed by tool 18.
2. For certain other screens (e.g., the key data and strategic alignment screens), a mouse-over translation will be available. In these screens a translation will be visible (e.g., by a pop-up window) as soon as the mouse curser is placed over the English term or phrase.

Also, in some embodiments, buttons, contents of list boxes, and error messages are not translated.

Translations can be made online in any language by authorized users with the role of a translator for tool 18 (e.g., using a test tool for gaining a realistic look and feel of the translated version before implementing into the live version of tool 18). An authorized translator may enter the translation mode by clicking on the “Edit translation” button on the welcome screen, e.g., shown in FIG. 12.

FIG. 62 illustrates an example screenshot 800 displayed by translation tool 39, for displaying English text into Japanese. Tool 39 may instruct the translator to translate or use html tags (e.g., <p>, <b> etc.) to provide text formatting. Tool 39 may further instruct the translator, after finalizing the translation, to inform a relevant system administrator or compliance officer to transfer the translation to the live version of tool 18.

It will be appreciated that systems, methods, and techniques disclosed herein may be similarly applied in other contexts. Additionally, it should be understood that various changes, substitutions and alterations can be made herein without departing from the spirit and scope of the disclosure as illustrated by the following claims.

What is claimed is:

1. A computer-implemented method for managing goodwill activities in a business organization, comprising:
collecting user-submitted activity identification data regarding a proposed activity via a computer network;
automatically classifying the proposed activity into one of a plurality of activity types based at least on the collected activity identification data;
collecting user-submitted activity value data regarding the proposed activity via the computer network;
automatically determining a value of the proposed activity based at least on the collected activity value data;
automatically selecting from a plurality of approval levels an approval level for the proposed activity based at least on the determined value of the proposed activity; and
facilitating an approval process for the proposed activity based at least on the approval level selected for the proposed activity, including facilitating approval decisions by a selected set of one or more approvers via the computer network.

2. A method according to claim 1, further comprising:
collecting user-submitted compliance risk data regarding potential legal or regulatory compliance risks related to the proposed activity;
automatically selecting the approval level for the proposed activity based at least on the determined value of the proposed activity and the collected compliance risk data.

3. A method according to claim 1, further comprising:
maintaining a set of data collection questions or prompts;
maintaining one or more value thresholds corresponding to each activity type;
comparing the determined value of the proposed activity with the one or more threshold values corresponding to the classified activity type of the proposed activity; and
automatically selecting one or more of the data collection questions or prompts to present to a user based at least on the results of the comparison, such that at least one of (a) the number and (b) the type of the selected data collection questions or prompts depends on the determined value of the proposed activity.

4. A method according to claim 1, further comprising automatically identifying at least one of the approvers or at least one potential approver based on the selected approval level for the proposed activity.

5. A method according to claim 1, further comprising:
automatically identifying a group of potential approvers based at least on the selected approval level; and
facilitating user selection of at least one of the approvers from the automatically identified group of potential approvers.

6. A method according to claim 1, wherein automatically selecting the approval level for the proposed activity comprises:
comparing the determined value of the proposed activity with one or more predefined threshold values corresponding to the classified activity type of the proposed activity; and
automatically selecting the approval level based at least on the results of the comparison.

7. A method according to claim 6, further comprising facilitating the modification of one or more predefined threshold values corresponding to one or more activity types by an authorized user.

8. A method according to claim 1, wherein the different approval levels differ from each other based on at least one of (a) the number and (b) the type of approvers that must be included in the set of approvers.

9. A method according to claim 1, wherein at least one approval level requires approval of proposed activities by one or more compliance organization members, and at least one other approval level does not require approval of proposed activities by any compliance organization members.

10. Software stored in tangible memory and executable by one or more processors to:
collect user-submitted activity identification data regarding a proposed activity via the computer network;
automatically classify the proposed activity into one of a plurality of activity types based at least on the collected activity identification data;
collect user-submitted activity value data regarding the proposed activity via the computer network;
automatically determine a value of the proposed activity based at least on the collected activity value data;
automatically select from a plurality of approval levels an approval level for the proposed activity based at least on the determined value of the proposed activity; and
facilitate an approval process for the proposed activity based at least on the approval level determined for the proposed activity, including facilitating approval decisions by a selected set of one or more approvers via the computer network.

11. Software according to claim 10, further executable to:
collect user-submitted compliance risk data regarding potential legal or regulatory compliance risks related to the proposed activity; and
automatically select the approval level for the proposed activity based at least on the determined value of the proposed activity and the collected compliance risk data.

12. Software according to claim 10, further executable to:
maintain a set of data collection questions or prompts;
maintain one or more value thresholds corresponding to each activity type;
compare the determined value of the proposed activity with the one or more threshold values corresponding to the classified activity type of the proposed activity; and
automatically select one or more of the data collection questions or prompts to present to a user based at least on the results of the comparison, such that at least one of (a) the number and (b) the type of the selected data collection questions or prompts depends on the determined value of the proposed activity.

13. Software according to claim 10, further executable to automatically identify at least one of the approvers or at least one potential approver based on the selected approval level for the proposed activity.

14. Software according to claim 10, wherein automatically selecting the approval level for the proposed activity comprises:
comparing the determined value of the proposed activity with one or more predefined threshold values corresponding to the classified activity type of the proposed activity; and
automatically selecting the approval level based at least on the results of the comparison.

15. A system for managing goodwill activities in a business organization, comprising:
a host device communicatively connected to a plurality of user devices by a computer network, the host device including a goodwill activity management tool embodied in tangible memory and executable by one or more processors, the goodwill activity management tool including:
an activity identification module for:
collecting user-submitted activity identification data regarding a proposed activity via the computer network;
automatically classifying the proposed activity into one of a plurality of activity types based at least on the collected activity identification data;
a key data module for:
collecting user-submitted activity value data regarding the proposed activity via the computer network;
automatically determining a value of the proposed activity based at least on the collected activity value data; and
an approval module for:
automatically selecting from a plurality of approval levels an approval level for the proposed activity based at least on the determined value of the proposed activity; and
facilitating an approval process for the proposed activity based at least on the approval level determined for the proposed activity, including facilitating approval decisions by a selected set of one or more approvers via the computer network.

16. A system according to claim 15, further comprising an assessment module for collecting user-submitted compliance risk data regarding potential legal or regulatory compliance risks related to the proposed activity; and
wherein the approval module is configured to automatically select the approval level for the proposed activity based at least on the determined value of the proposed activity and the collected compliance risk data.

17. A method according to claim 15, wherein the approval module is configured to automatically identify at least one of the approvers or at least one potential approver based on the selected approval level for the proposed activity.

18. A method according to claim 15, wherein automatically selecting the approval level for the proposed activity comprises:
comparing the determined value of the proposed activity with one or more predefined threshold values corresponding to the classified activity type of the proposed activity; and
automatically selecting the approval level based at least on the results of the comparison.

19. A method according to claim 15, wherein the goodwill activity management tool is configured to:
maintain a set of data collection questions or prompts;
maintain one or more value thresholds corresponding to each activity type;
compare the determined value of the proposed activity with the one or more threshold values corresponding to the classified activity type of the proposed activity; and
automatically select one or more of the data collection questions or prompts to present to a user based at least on the results of the comparison, such that at least one of (a) the number and (b) the type of the selected data collection questions or prompts depends on the determined value of the proposed activity.
